(19) United States
(12) Patent Application Publication
(10) Pub. No.: US 2025/0125457 A1
(43) Pub. Date: Apr. 17, 2025

(54) LITHIUM BATTERY

(71) Applicant: Samsung Electronics Co., Ltd., Suwon-si (KR)

(72) Inventor: Jirae Kim, Suwon-si (KR)

(21) Appl. No.: 18/911,349

(22) Filed: Oct. 10, 2024

(30) Foreign Application Priority Data
Oct. 13, 2023 (KR) 10-2023-0137036

(51) Int. Cl. H01M 50/136; H01M 10/052; H01M 50/119

(52) U.S. Cl. CPC H01M 50/136; H01M 10/052; H01M 50/119

(57) ABSTRACT

A lithium battery including a unit cell stack including a plurality of unit cells stacked in a thickness direction thereof; and a battery case for accommodating the unit cell stack, wherein the battery case includes an upper surface portion adjacent to an upper end surface of the unit cell stack, a lower surface portion adjacent to a lower end surface of the unit cell stack, and a side portion connecting the upper surface portion and the lower surface portion, and the side portion includes a corrugated portion disposed in the thickness direction of the unit cell stack.

### CROSS-REFERENCE TO RELATED APPLICATION

This application claims priority to and the benefit of Korean Patent Application No. 10-2023-0137036, filed on Oct. 13, 2023, and all the benefits accruing therefrom under 35 U.S.C. § 119, in the Korean Intellectual Property Office, the content of which in its entirety is herein incorporated by reference.

### BACKGROUND

### 1. Field

The disclosure relates to a lithium battery.

### 2. Description of the Related Art

Batteries that provide increased energy density and safety are desired. Lithium batteries may be used in information devices, communication devices, automobiles, energy storage systems, etc.

Lithium batteries, including liquid electrolytes, include flammable organic solvents. Lithium batteries with liquid electrolytes may have a high risk of overheating and fire in the event of a short circuit.

Compared to liquid electrolytes, solid electrolytes may be less likely to overheat and be set on fire in the event of a short circuit. Lithium batteries with a solid electrolyte may provide improved safety as compared to lithium batteries with a liquid electrolyte.

### SUMMARY

In a lithium battery, a unit cell stack is placed within a battery case. The unit cell stack may include a solid electrolyte layer, and an elastic member may be disposed between the unit cell stack and the battery case to alleviate volume changes during charge and discharge of the unit cell stack and to apply a constant pressure to the unit cell stack. An elastic member may be disposed between the unit cell stack and the battery case, and the energy density of the lithium battery may be decreased. In lithium batteries that do not include a separate elastic member in the battery case, cycle characteristics deteriorate due to an increase in interfacial resistance between a solid electrolyte layer and an electrode caused by change in volume of the lithium battery during the charging and discharging process. There is a desire for a lithium battery with a new structure that prevents a decrease in energy density and cycle characteristics of the lithium battery.

Provided is a lithium battery that has a new structure. A decrease in energy density may be suppressed and a decrease in cycle characteristics may be prevented.

Additional aspects will be set forth in part in the description which follows and, in part, will be apparent from the description, or may be learned by practice of the presented embodiments of the disclosure.

According to an aspect of the disclosure,
a lithium battery includes a unit cell stack including a plurality of unit cells stacked in a thickness direction, and
a battery case accommodating the unit cell stack,
wherein the battery case may include an upper surface portion adjacent to an upper end surface of the unit cell stack, a lower surface portion adjacent to a lower end surface of the unit cell stack, and a side portion connecting the upper surface portion and the lower surface portion, and
the side portion of the battery case includes a corrugated portion disposed in a thickness direction of the unit cell stack.

According to an aspect of the disclosure,
a battery case configured for a lithium battery includes a first surface portion adjacent to a first end surface of the unit cell stack, a second surface portion adjacent to a second end surface of the unit cell stack, and a side portion connecting the first surface portion and the second surface portion to each other,
wherein the side portion comprises a corrugated portion disposed in a thickness direction of the unit cell stack,
a distance between opposite ends of the corrugated portion is about 1% to about 80% of a distance between the first surface portion and the second surface portion,
the corrugated portion is spaced apart from each of the first surface portion and the second surface portion,
the battery case comprises stainless steel, and
the corrugated portion comprises an elastic material comprising stainless steel.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional schematic view of the side of an embodiment of a lithium battery;

FIG. 2 is a cross-sectional schematic view of a lithium battery of the prior art;

FIG. 3 is a perspective view of an embodiment of a lithium battery;

FIG. 4 is a perspective view of an embodiment of a lithium battery;

FIG. 5 is a cross-sectional schematic view of an embodiment of the side of a lithium battery;

FIG. 6 is a cross-sectional schematic view of an embodiment of the side of a lithium battery;

FIG. 7 is a cross-sectional schematic view of an embodiment of the side of a lithium battery;

FIG. 8 is a cross-sectional schematic view of an embodiment of the side of a lithium battery;

FIG. 9 is a side view of an embodiment of a lithium battery;

FIG. 10 is a side view of an embodiment of a lithium battery;

FIG. 11A is an enlarged view of a portion of protrusions illustrated in FIG. 6;

FIG. 11B is an enlarged view of a portion of depressions illustrated in FIG. 7;

FIG. 12A is an enlarged view of a portion of a corrugated portion including protrusions that are apart from each other;

FIG. 12B is an enlarged view of a portion of a corrugated portion including depressions that are apart from each other;

FIG. 13 is an enlarged view of a portion of a corrugated portion of FIG. 8;

FIG. 14 is a cross-sectional schematic view of an embodiment of the side of a lithium battery;

FIG. 15 is a cross-sectional schematic view of an embodiment of the side of a lithium battery;

FIG. 16 is a cross-sectional schematic view of an embodiment of the side of a lithium battery; and

FIG. 17 is a cross-sectional schematic view of an embodiment of the side of a lithium battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” preceding a list of elements, modify the entire list of elements and do not modify the individual elements of the list.

The present inventive concept described hereinafter may be modified in various ways, and may have many examples, and thus, certain examples are illustrated in the drawings, and are described in detail in the specification. The present inventive concept may, however, should not be construed as limited to the example embodiments set forth herein, and rather, should be understood as covering all modifications, equivalents, or alternatives falling within the scope of the present inventive concept.

The terms used herein is for the purpose of describing particular embodiments only, and is not intended to be limiting the present inventive concept. An expression used in the singular encompasses the expression of the plural, unless it has a clearly different meaning in the context. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. Thus, reference to “an” element in a claim followed by reference to “the” element is inclusive of one element and a plurality of the elements. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The sign “/” used herein may be interpreted as “and,” or as “or” depending on the context.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used, e.g., non-technical, dictionaries, should be interpreted as having a meaning that is consistent with their meaning in the context of the relevant art and the present disclosure, and will not be interpreted in an idealized or overly formal sense unless expressly so defined herein.

In the drawings, thicknesses may be magnified or exaggerated to clearly illustrate various layers and regions. It will be understood that when one element, layer, film, section, sheet, etc. is referred to as being “on” another element, it can be directly on the other element or intervening elements may be present therebetween. Although the terms “first,” “second,” etc. may be used herein to describe various elements, these elements should not be limited by these terms. These terms are only used to distinguish one element from another element.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, a C-rate means a current which will discharge a battery in one hour, e.g., a C-rate for a battery having a discharge capacity of 1.6 ampere-hours would be 1.6 amperes.

The term “metal” used herein includes both metals and metalloids such as silicon and germanium, in an elemental or ionic state.

The term “alloy” used herein refers to a mixture of two or more metals.

The term “cathode active material” used herein refers to a cathode material capable of undergoing lithiation and delithiation.

The term “anode active material” used herein refers to an anode material capable of undergoing lithiation and delithiation.

The terms “lithiation” and “lithiate” used herein refer to a process of adding lithium to a cathode active material or an anode active material.

The terms “delithiation” and “delithiate” used herein refer to a process of removing lithium from a cathode active material or an anode active material.

The terms “charging” and “charge” used herein refer to a process of providing electrochemical energy to a battery.

The terms “discharging” and “discharge” used herein refer to a process of removing electrochemical energy from a battery.

The term “cathode” used herein refer to an electrode in which electrochemical reduction and lithiation occur during a discharging process.

The term “anode” used herein refer to an electrode in which electrochemical oxidation and delithiation occurs during the discharging process.

The term “particle diameter” of a particle used herein refers to the average diameter in the case where the particle is spherical, and the average major axis length in the case where the particle is non-spherical. The particle diameter of the particles may be measured using a particle size analyzer (PSA). The “particle diameter” of a particle may be, for example, the average particle diameter. The average particle diameter is a median particle diameter (D50) unless explicitly stated otherwise. The median particle diameter (D50) is the size of a particle that corresponds to a cumulative value of 50%, calculated from the side of the particle with the smallest particle size in a cumulative distribution curve of particle sizes where particles are accumulated in order of size from smallest to largest. The cumulative value may be, for example, a cumulative volume. Median particle diameter (D50) may be measured by, for example, laser diffraction.

Hereinafter, lithium batteries according to an embodiment will be described in more detail.

### Lithium Battery

A lithium battery according to an embodiment includes: a unit cell stack including a plurality of unit cells stacked in the thickness direction; and a battery case for accommodating the unit cell stack, wherein the battery case includes a first, e.g., upper, surface portion adjacent to a first, e.g., upper, end surface of the unit cell stack, a second, e.g., lower, surface portion adjacent to the second, e.g., lower, end surface of the unit cell stack, and a side portion connecting the upper surface portion to the lower surface portion, wherein the side portion includes a corrugated portion disposed in a thickness direction of the unit cell stack.

The side portion of the battery case may include a corrugated portion disposed in the thickness direction of the unit cell stack, and the battery case may effectively tolerate changes in volume in the thickness direction during charge and discharge of the unit cell stack. The corrugated portion of the battery case may apply a certain pressure between the upper end surface and the lower end surface of the unit cell stack through the upper surface portion and the lower surface portion thereof, the increase in interfacial resistance between a solid electrolyte layer and an electrode due to the volume change during charge and discharge of the unit cell stack may be suppressed, and the cycle characteristics of a lithium battery may be improved. The battery case may also function as a pressing member, additional pressing members within the battery case may be omitted, and the energy density of the lithium battery may be improved.

An additional pressing member may be omitted in the battery case, and the interfacial resistance between the pressing member and the unit cell stack and the interfacial resistance between the pressing member and the battery case may be eliminated. The internal resistance of the lithium battery may be reduced, and the cycle characteristics of the lithium battery may be improved.

The side portion of the battery case may include the corrugated portion disposed in the thickness direction of the unit cell stack, and the actual area of the battery case may be increased. The surface area of the lithium battery may be increased, and heat generated during charge and discharge of the lithium battery may be more effectively dissipated to the outside of the battery case. The heat dissipation characteristics of the lithium battery are improved, and due to the improvement of the heat dissipation characteristics of the lithium battery, the thermal stability and high temperature stability of the lithium battery may be improved.

In lithium batteries that do not include a corrugated portion in the battery case, a separate pressing member may be additionally disposed within the battery case to apply a certain pressure to the unit cell stack, and the energy density of the lithium battery is decreased. Lithium batteries that do not include a corrugated portion in a battery case and are not provided with a pressing member, may have difficulty in suppressing an increase in interfacial resistance between a solid electrolyte layer and an electrode due to volume changes during charge and discharge of the unit cell stack, and the cycle characteristics of the lithium battery may deteriorate.

A lithium battery according to an embodiment will be described in more detail with reference to the drawings.

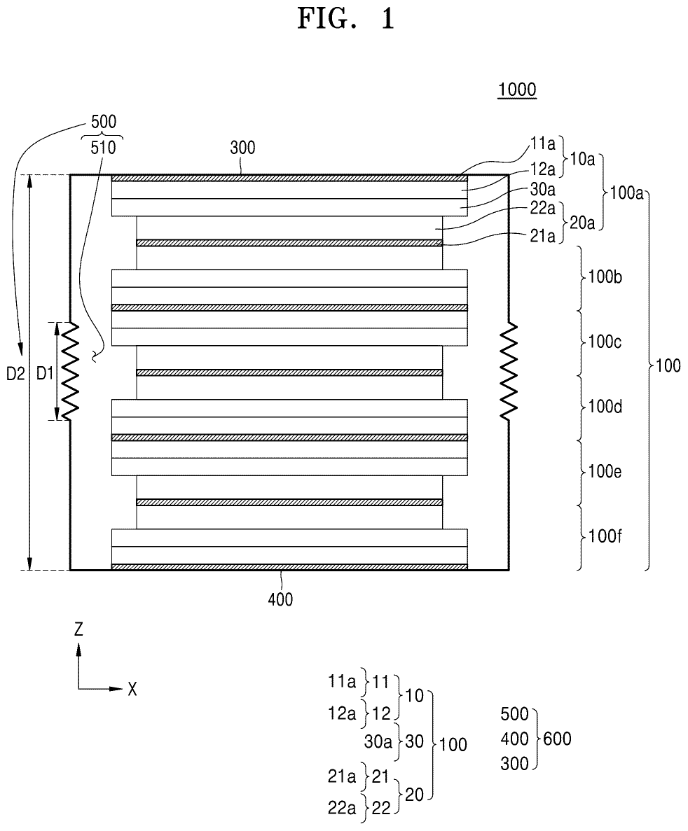

FIGS. 1 and 3 to 17, the lithium battery 100 includes a unit cell stack 200 including a plurality of unit cells 100a, 100b, 100c, 100d, 100e, and 100f stacked in the thickness direction thereof and a battery case 600 accommodating the unit cell stack 200. The battery case 600 may include an upper surface portion 300 adjacent to the upper end surface of the unit cell stack 200, a lower surface portion 400 adjacent to the lower end surface of the unit cell stack 200, and a side portion 500 connecting the upper surface portion 300 and the lower surface portion 400 to each other. The side portion 500 includes a corrugated portion 510 disposed in the thickness direction of the unit cell stack 200. The side portion 500 may include the corrugated portion 510, and the volume change in the thickness direction (z direction in FIG. 1) of the unit cell stack 200 may be effectively tolerated during charge and discharge of the lithium battery 1000. By pressing the unit cell stack 200 through the upper surface portion 300 and the lower surface portion 400, the side portion 500 may suppress an increase in the interfacial resistance between a solid electrolyte layer and an electrode due to change in volume of the unit cell stack 200. The side portion 500 may include the corrugated portion 510, the surface area of the battery case 600 may be increased, and heat generated during charge and discharge of the lithium battery 100 may be more effectively dissipated to the outside. The thermal stability and high temperature stability of the lithium battery 100 may be improved.

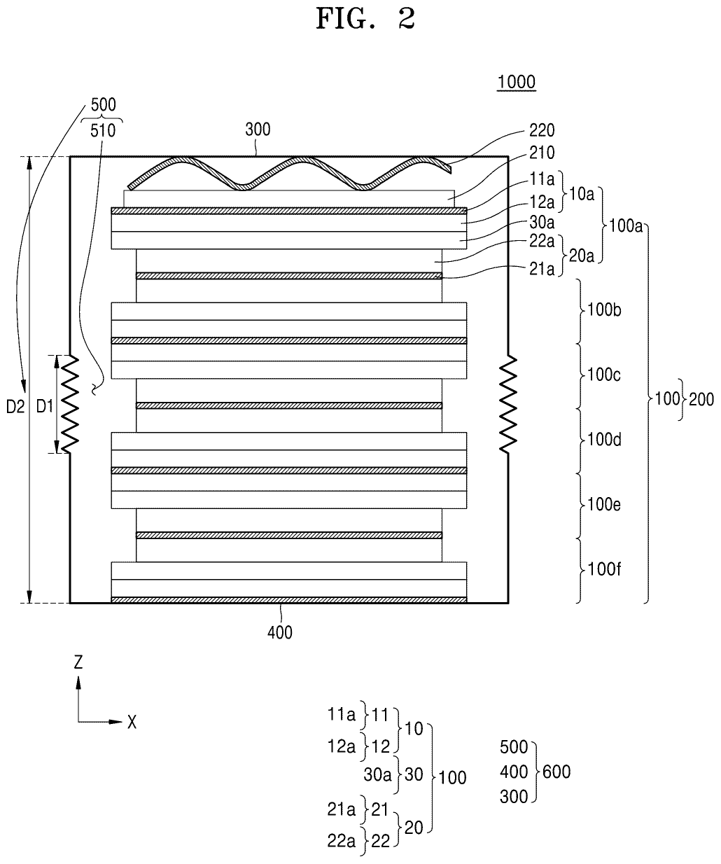

Referring to FIG. 2, a lithium battery 1000 that does not include a corrugated portion in the side portion 500, may further include an elastic member 220 to tolerate changes in volume change in the thickness direction of the unit cell stack 200 (z direction in FIG. 2) during charge and discharge of the lithium battery 1000. A spacer 210 may be further included to allow the elastic member 220 to provide uniform pressure to the unit cell stack 200, the volume of space excluding the unit cell stack 200 within the battery case 600 defined by the upper surface portion 300, lower surface portion 400, and side portion 400, may be increased, and the energy density per unit volume of the lithium battery 1000 may be decreased. The elastic member 220, the spacer 210, or a combination thereof may include, for example, a metal-based material, and the weight of the lithium battery 1000 may be increased and the energy density per unit weight of the lithium battery 1000 may be decreased.

Referring to FIGS. 1 to 2, 5 to 8, and 14 to 17, a unit cell 100a includes a first electrode layer 10a, a second electrode layer 20a, and an electrolyte layer 30a between the first electrode layer 10a and the second electrode layer 20a. The first electrode layer 10a may include a first electrode current collector 11a and a first electrode active material layer 12a. The second electrode layer 20a may include a second electrode current collector 21a and a second electrode active material layer 22a. The electrolyte layer 30a may include, for example, a solid electrolyte layer. Inside the unit cell stack 200, a first electrode and a second electrode may each be a double-sided electrode. A double-sided electrode has a structure in which an electrode active material layer is disposed on opposite sides of an electrode current collector. The first electrode layer 10a may be, for example, an anode layer. The first electrode current collector 11a may be, for example, an anode current collector. The first electrode active material layer 12a may be, for example, an anode active material layer. The second electrode layer 20a may be, for example, a cathode layer. The second electrode current collector 21a may be, for example, a cathode current collector. The second electrode active material layer 22a may be, for example, a cathode active material layer.

Referring to FIGS. 1 to 17, the battery case 600 may include a metal-based material or may be formed of a metal-based material. Metal-based materials may include, for example, stainless steel (“SUS”), copper (Cu), nickel (Ni), aluminum (Al), indium (In), magnesium (Mg), titanium (Ti), iron (Fe), cobalt (Co), zinc (Zn), germanium (Ge), or an alloy thereof. The battery case 600 may include, for example, stainless steel. The battery case 600 may hardly or may not undergo the volume increase caused by change in temperature of the lithium battery 1000. The battery case 600 may not be a stacked laminate sheet.

Referring to FIGS. 1 and 3 to 17, a first distance D1 between opposite ends of the corrugated portion 510, e.g., a length of the corrugated portion 510, may be, for example, 80% or less, 60% or less, 50% or less, 40% or less, 30% or less, 20% or less, or 10% or less of a second distance D2 between the upper surface portion 300 and the lower surface portion 400. The first distance D1 between opposite ends of the corrugated portion 510 may be, for example, about 1% to about 80%, about 1% to about 60%, about 1% to about 50%, about 1% to about 40%, about 1% to about 30%, about 1% to about 20%, or about 1% to about 10% of the second distance D2 between the upper surface portion 300 and the lower surface portion 400. When the first distance D1 of the corrugated portion 510 is within the disclosed ranges, changes in volume in the thickness direction of the unit cell stack 200 may be effectively tolerated and more uniform pressure may be applied to the unit cell stack 200. When the first distance D1 between opposite ends of the corrugated portion 510 is too small, it may be difficult to achieve the intended effect. When the first distance D1 between opposite ends of the corrugated portion 510 is too large, the mechanical strength of the battery case 600 may be decreased.

Referring to FIGS. 1 and 3 to 17, the corrugated portion 510 may be spaced apart from each of the upper surface portion 300 and the lower surface portion 400. By arranging the corrugated portion 510 to be spaced apart from the upper surface portion 300 and the lower surface portion 400, more uniform pressure may be applied to the upper end surface and the lower end surface of the unit cell stack 200. The corrugated portion 510 may contact the upper surface portion 300, the lower surface portion 400, or a combination thereof, and the mechanical strength of the upper surface portion, the lower surface portion, or a combination thereof may be decreased. The ratio of the distance that the corrugated portion 510 is spaced from the upper surface portion 300 to the distance that the corrugated portion 510 is spaced from the lower surface portion 400 may be, for example, 10:1 to 1:10, 5:1 to 1.:5, 3:1 to 1:3, 2:1 to 1:2 or 1.2:1 to 1:1.2.

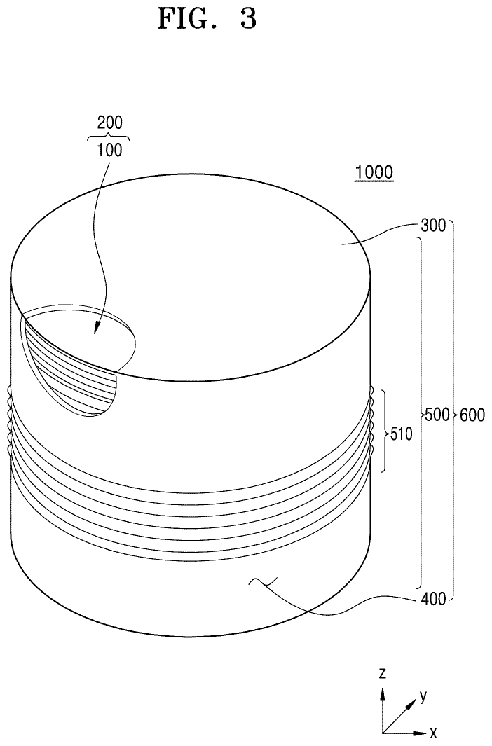

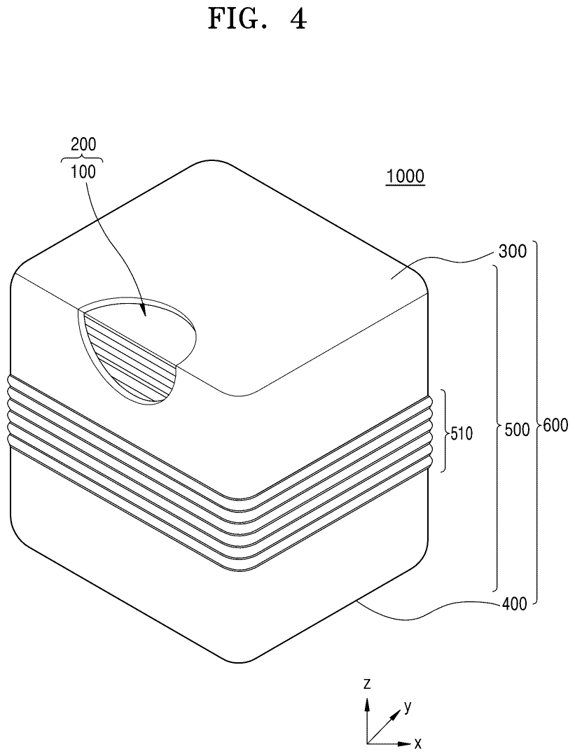

Referring to FIGS. 3 and 4, the corrugated portion 510 may surround the outer periphery of the unit cell stack 200 in a direction perpendicular to the thickness direction of the unit cell stack 200. The corrugated portion 510 surrounds the outer periphery of the unit cell stack 200, during charge and discharge of the lithium battery 1000, the volume change in the thickness direction (z direction in FIGS. 3 and 4) of the unit cell stack 200 may be more effectively tolerated, and the heat generated during charge and discharge of the lithium battery 1000 may be more effectively dissipated to the outside of the lithium battery 1000. For example, the corrugated portion 510 may surround, for example, 50% or greater, 60% or greater, or 70% or greater, 80% or greater, 90% or greater, or 100% of the outer periphery of the unit cell stack 200 in a direction perpendicular to the thickness direction of the unit cell stack 200. In an embodiment, the corrugated portion 510 may surround, for example, about 50% to about 100%, about 60% to about 100%, about 70% to about 100%, about 80% to about 100%, or about 90% to about 100% of the outer periphery of the unit cell stack 200 in a direction perpendicular to the thickness direction of the unit cell stack 200.

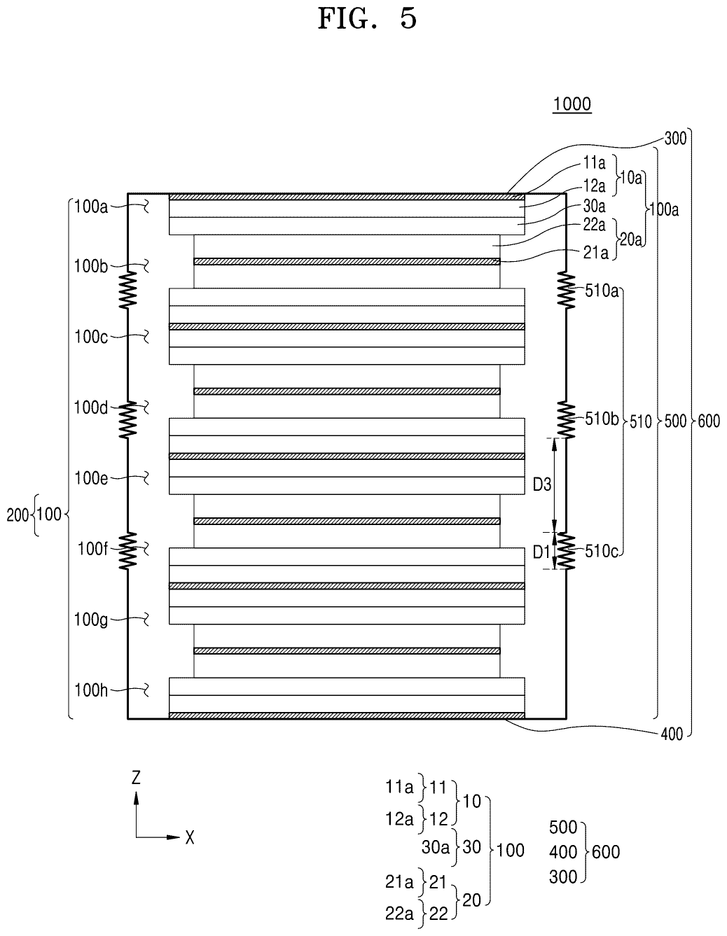

Referring to FIG. 5, the side portion 500 may include the corrugated portion 510 including a plurality of corrugated portions 510a, 510b, and 510c. The side portion 500 may include the corrugated portion 510 including a plurality of corrugated portions, the volume change in the thickness direction (z direction in FIG. 5) of the unit cell stack 200 may be more effectively tolerated during charge and discharge of the lithium battery 1000, and heat generated during charge and discharge of the lithium battery 1000 may be more effectively dissipated to the outside of the lithium battery 1000. The side portion 500 may include the corrugated portion 510 including a plurality of corrugated portions, and an increase in interfacial resistance between a solid electrolyte layer and an electrode due to change in volume of the unit cell stack 200 may be more effectively suppressed. The number of the plurality of corrugated portions of the corrugated portion 510 may be, for example, 2 to 100, 2 to 50, 2 to 10, or 2 to 5. The plurality of corrugated portions of the corrugated portion 510 are spaced apart from each other in the thickness direction of the unit cell stack 200. A distance D3 between adjacent ones of the plurality of corrugated portions of the corrugated portion 510 spaced apart from each other may be, for example, about 10% to about 500%, 50% to about 200%, or 100% to about 200% of the distance D1 of one of the plurality of corrugated portions. When the distance D3 between adjacent ones of the plurality of corrugated portions of the corrugated portion 510 spaced apart from each other is within the disclosed ranges, the volume change in the thickness direction (z direction in FIG. 5) of the unit cell stack 200 may be more effectively tolerated during charge and discharge of the lithium battery 1000, and a decrease in the mechanical strength of the battery case 600 may be prevented.

Referring to FIGS. 1 and 3 to 17, the inner surface of the corrugated portion 510 may be disposed to be spaced apart from the side of the unit cell stack 200. By arranging the inner surface of the corrugated portion 510 to be spaced apart from the side of the unit cell stack 200, a short circuit with the electrode current collector exposed on the side of the unit cell stack 200 may be more effectively prevented and the volume change of the unit cell stack 200 may be more effectively tolerated during charge and discharge of the lithium battery 1000. The distance between the inner surface of the corrugated portion 510 and the side of the unit cell stack 200 may be 1% or greater, 5% or greater, or 10% or greater of the diameter of the upper surface portion 300 or the lower surface portion 400 of the battery case 600. The distance between the inner surface of the corrugated portion 510 and the side of the unit cell stack 200 may be about 1% to about 30%, about 5% to about 25%, or about 10% to about 20% of the diameter of the upper surface portion 300 or the lower surface portion 400 of the battery case 600. When the distance between the inner surface of the corrugated portion 510 and the side of the unit cell stack 200 is increased excessively, the energy density of the lithium battery 1000 may be decreased.

Referring to FIGS. 1 and 3 to 17, the corrugated portion 510 may include an elastic material. The corrugated portion 510 may include an elastic material, and the change in volume in the thickness direction (z direction in FIG. 1) of the unit cell stack 200 during charge and discharge of the lithium battery 1000 may be more effectively tolerated and the increase in interfacial resistance between a solid electrolyte layer and an electrode may be suppressed. The corrugated portion 510 may include an elastic material, the battery case 600 may apply a constant pressure to the unit cell stack 200 through the upper surface portion 300, the lower surface portion 400, and the side portion 500 without any additional elastic members, and an increase in the interfacial resistance between a solid electrolyte layer and an electrode due to a volume change of the unit cell stack 200 during charge and discharge of the lithium battery 100 may be suppressed. The corrugated portion 510 may include or is formed of an elastic material. Elastic materials are materials that have elasticity and resilience. The elastic material may be, for example, a metal-based material. Metal-based materials include, for example, stainless steel (“SUS”), copper (Cu), nickel (Ni), aluminum (Al), indium (In), magnesium (Mg), titanium (Ti), iron (Fe), cobalt (Co), zinc (Zn), germanium (Ge), or an alloy thereof. Metallic materials may have ductility. The metal-based material may be any suitable material that has electronic conductivity and elasticity without reacting with lithium. Some or all of the corrugated portion 510 may include, for example, an elastic material.

Referring to FIGS. 1 and 3 to 17, the corrugated portion 510 may include a plurality of protrusions 511, a plurality of depressions 512, or a combination thereof, which are arranged in the thickness direction of the unit cell stack 200. Herein, a plurality of protrusions 511, a plurality of depressions 512, or a combination thereof is also collectively referred to as undulations.

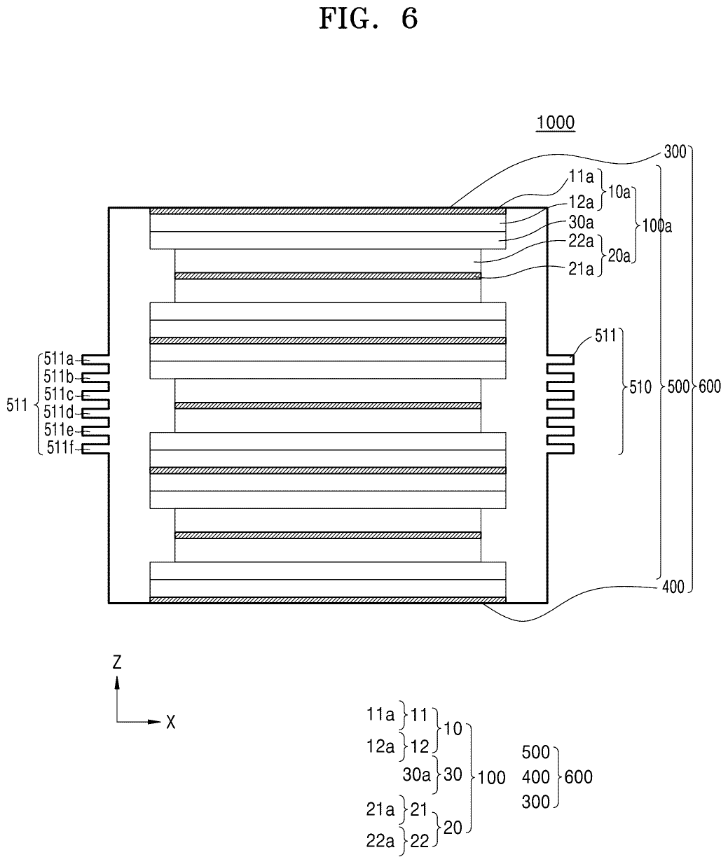

Referring to FIG. 6, the corrugated portion 510 may include the plurality of protrusions 511 including protrusions 511a, 511b, 511c, 511d, 511e, and 511f. The corrugated portion 510 may not include depressions. The corrugated portion 510 may include the plurality of protrusions 511, and the unit cell stack 200 may be more easily accommodated inside the battery case 600. The corrugated portion 510 may include the plurality of protrusions 511, and heat generated during charge and discharge of the lithium battery 1000 may be more effectively dissipated to the outside of the lithium battery 1000. The plurality of protrusions 511 may function as a type of heat sink, and the thermal stability, high temperature stability, or a combination thereof of the lithium battery 1000 may be improved.

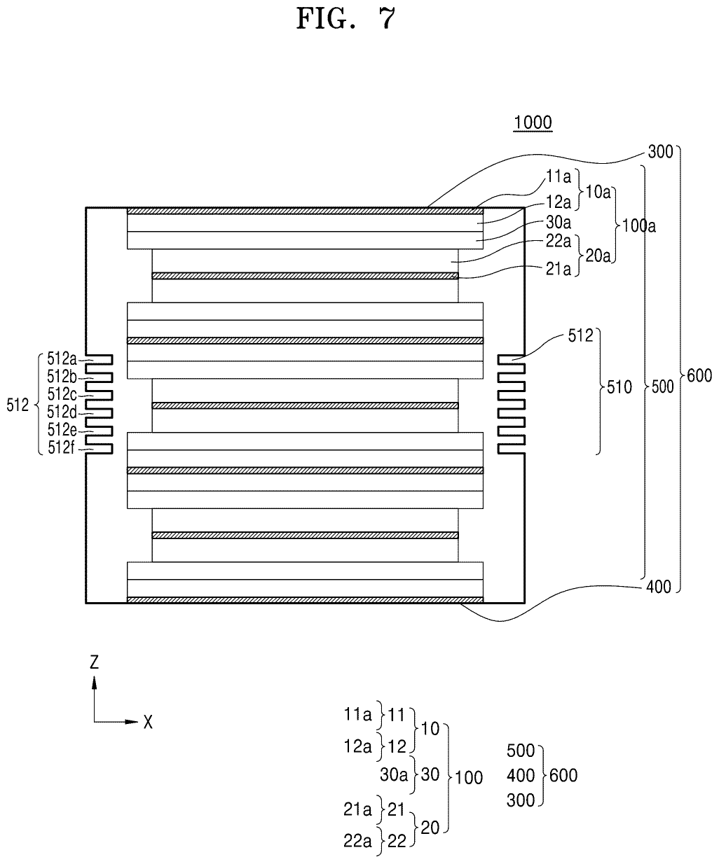

Referring to FIG. 7, the corrugated portion 510 may include the plurality of depressions 512 including depressions 512a, 512b, 512c, 512d, 512e, and 512f. The corrugated portion 510 may not include protrusions. The corrugated portion 510 may include the plurality of depressions 512, the plurality of lithium batteries 1000 may be more densely arranged in a module or pack including the plurality of lithium batteries 1000, and the energy density of a module or pack including the plurality of lithium batteries 1000 may be improved. The plurality of depressions 512 may function as a type of heat sink, and the thermal stability, high temperature stability, or a combination thereof of the lithium battery 1000 may be improved.

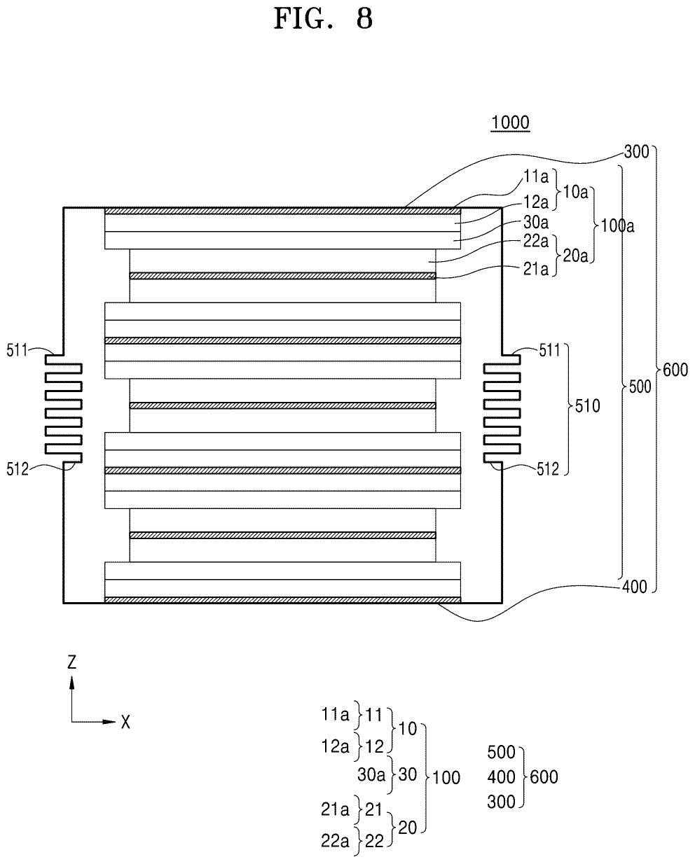

Referring to FIG. 8, the corrugated portion 510 may include the plurality of protrusions 511 and the plurality of depressions 512. The corrugated portion 510 may include the plurality of protrusions 511 and the plurality of depressions 512, and heat generated during charge and discharge of the lithium battery 1000 may be more effectively dissipated to the outside of the lithium battery 1000. The plurality of protrusions 511 and the plurality of depressions 512 may act as a heat sink, and the thermal stability, high temperature stability, or a combination thereof of the lithium battery 1000 may be further improved.

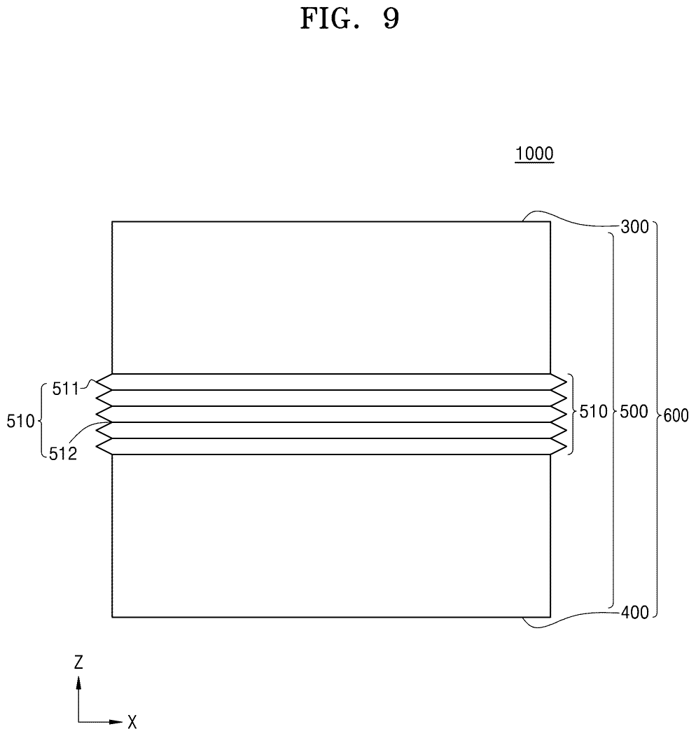

Referring to FIG. 9, the plurality of protrusions 511, the plurality of depressions 512, or a combination thereof may each independently surround the outer periphery of the unit cell stack 200, e.g., the plurality of protrusions 511 may surround the outer periphery of the unit cell stack 200, the plurality of depressions 512 may surround the outer periphery of the unit cell stack 200, or the plurality of protrusions 511 may surround the outer periphery of the unit cell stack 200 and the plurality of depressions 512 may surround the outer periphery of the unit cell stack 200.

The plurality of protrusions 511, the plurality of depressions 512, or a combination thereof may each independently surround the outer periphery of the unit cell stack 200, and even if a defect occurs in a portion of the plurality of protrusions 511 and the plurality of depressions 512, the influence of the defect on the other portions of the plurality of protrusions 511 and the plurality of depressions 512 may be minimized. The plurality of protrusions 511 may form a complete ring surrounding the outer periphery of the unit cell stack 200. The plurality of depressions 512 may each form a complete ring surrounding the outer periphery of the unit cell stack 200. Although not shown in the drawing, the plurality of protrusions 511 may be spaced apart from each other in the thickness direction of the unit cell stack 200, and the plurality of depressions 512 may be spaced apart from each other in the thickness direction of the unit cell stack 200.

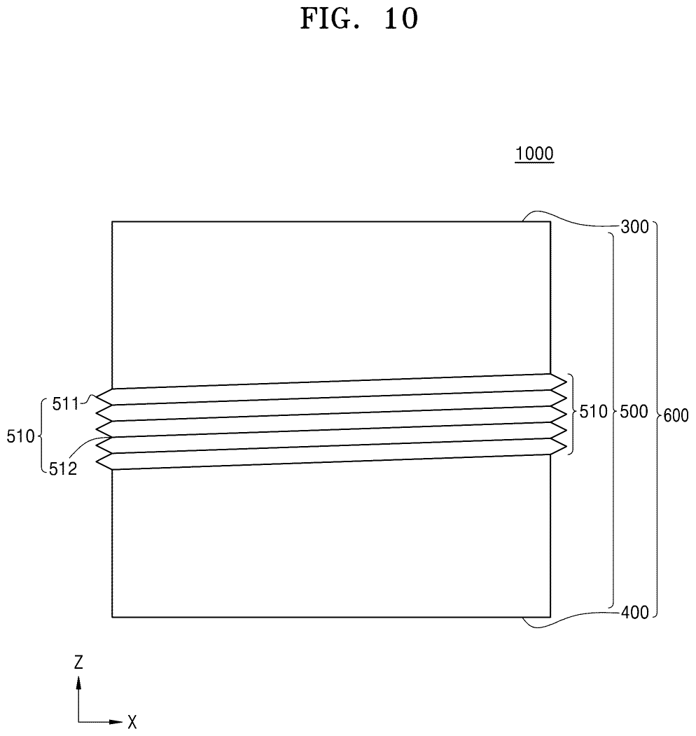

Referring to FIG. 10, the plurality of protrusions 511, the plurality of depressions 512, or a combination thereof may be helically coiled and surround the outer periphery of the unit cell stack 200. The plurality of protrusions 511, the plurality of depressions 512, or a combination thereof may be helically coiled and surround the outer periphery of the unit cell stack 200, and the plurality of protrusions 511, the plurality of depressions 512, or a combination thereof may have a shape similar to a single spring, for example. The change in volume in the thickness direction (z direction in FIG. 2) of the unit cell stack 200 during charge and discharge of the lithium battery 1000, may be more effectively tolerated, and the increase in interfacial resistance between a solid electrolyte layer and an electrode may be suppressed. The plurality of protrusions 511 may form part of an unfinished spiral ring surrounding the outer periphery of the unit cell stack 200 multiple times. The plurality of depressions 512 may form part of an unfinished spiral ring that surrounds the outer periphery of the unit cell stack 200 multiple times. Although not shown in the drawing, the plurality of protrusions 511 and the plurality of depressions 512 may be spaced apart from each other in the thickness direction of the unit cell stack 200.

Referring to FIGS. 1 and 3 to 17, the number of plurality of protrusions 511 and the number of the plurality of depressions 512, included in the corrugated portion 510, may independently be (e.g., the number of undulations may be), for example, 5 to 1,000, 5 to 500, 5 to 100, and 5 to 50, 5 to 20, or 5 to 10. When the number of the plurality of protrusions 511 or plurality of depressions 512 included in the corrugated portion 510 is within the disclosed ranges, the volume changes in the thickness direction (z direction in FIG. 2) of the unit cell stack 200 during charge and discharge of the lithium battery 1000 may be effectively tolerated, and the increase in interfacial resistance between a solid electrolyte layer and an electrode may be suppressed, and heat generated during charge and discharge of the lithium battery 1000 may be more effectively dissipated to the outside of the lithium battery 1000.

Although not shown in the drawing, the shapes of the plurality of protrusions 511, the plurality of depressions 512, or a combination thereof included in the corrugated portion 510 may be the same. When the plurality of protrusions 511, the plurality of depressions 512, or a combination thereof have the same shape, manufacturing may be facilitated and the occurrence of defects may be reduced. The shapes of the plurality of protrusions 511, the plurality of depressions 512, or a combination thereof included in the corrugated portion 510 may be different from each other. The plurality of protrusions 511, the plurality of depressions 512, or a combination thereof included in the corrugated portion 510 may have different shapes, and a structure more suitable for the desired use may be obtained. For example, in the case of a lithium battery for which improved heat dissipation characteristics are desired, the height of the plurality of protrusions 511 and the depth of the plurality of depressions 512 may be changed to be different from each other to maximize the heat dissipation effect.

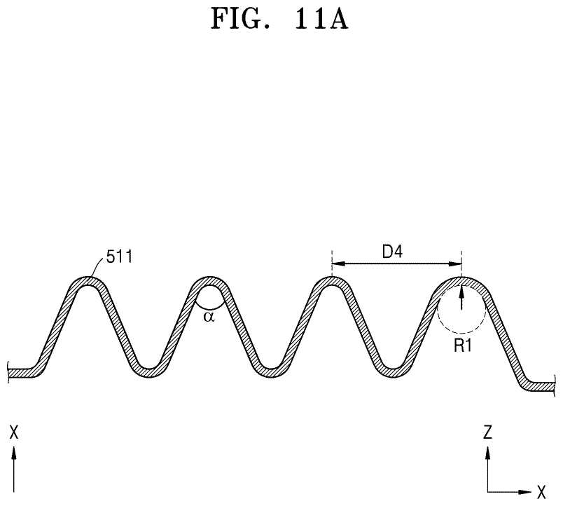

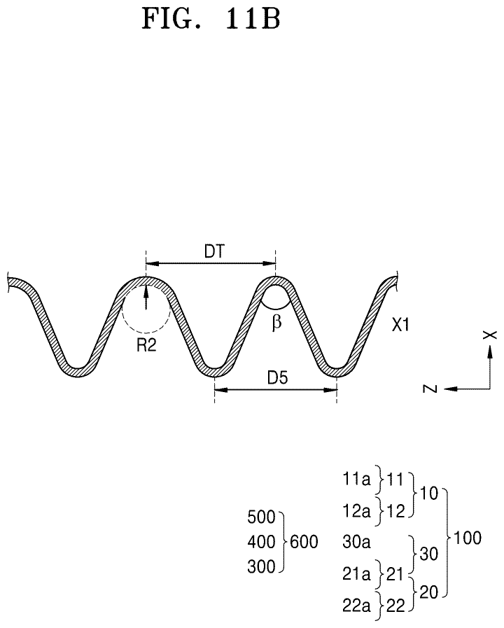

FIGS. 11A and 11B are enlarged views of a portion of the corrugated portion 510 of FIG. 1.

Referring to FIG. 11A, a bending angle α1 of the plurality of protrusions 511 may be, for example, about greater than 0 degrees to about 120 degrees, greater than 0degrees to about 90 degrees, greater than 0 degrees to about 60 degrees, greater than 0 degrees to about 45 degrees, greater than 0 degrees to about 30 degrees, or greater than 0 degrees to about 15 degrees. Referring to FIG. 11B, a bending angle α2 of the plurality of depressions 512 may be, for example, greater than about 0 degrees to about 120 degrees, greater than 0 degrees to about 90 degrees, greater than 0 degrees to about 60 degrees, greater than 0 degrees to about 45 degrees, greater than 0 degrees to about 30 degrees, or greater than 0 degrees to about 15 degrees. When the bending angle α1 of the plurality of protrusions 511 and the bending angle α2 of the plurality of depressions 512 each independently are within the disclosed ranges, the change in volume in the thickness direction (z direction in FIGS. 9A and 9B) of the unit cell stack 200 during charge and discharge of the lithium battery 1000 may be effectively tolerated, the increase in interfacial resistance between a solid electrolyte layer and an electrode may be suppressed, and the heat generated during charge and discharge of the lithium battery 1000 may be more effectively dissipated to the outside of the lithium battery 1000. Referring to FIG. 11A, the curvature radius R1 of the plurality of protrusions 511 may be, for example, 10 millimeters (mm) or less, 5 mm or less, or 1 mm or less. The curvature radius R1 of the plurality of protrusions 511 may be, for example, about 0 mm to about 10 mm, about 0 mm to about 5 mm, or about 0 mm to about 1 mm. Referring to FIG. 11B, the curvature radius R2 of the plurality of depressions 512 may be, for example, 10 mm or less, 5 mm or less, or 1 mm or less. The curvature radius R2 of the plurality of depressions 512 may be, for example, about 0 mm to about 10 mm, about 0 mm to about 5 mm, or about 0 mm to about 1 mm. When the curvature radius R1 of the plurality of protrusions 511 and the curvature radius R2 of the plurality of depressions 512 are independently within the disclosed ranges, the volume change in the thickness direction (z direction in FIGS. 9A and 9B) of the unit cell stack 200 during charge and discharge of the lithium battery 1000 may be more effectively tolerated, and the increase in interfacial resistance between a solid electrolyte layer and an electrode may be suppressed, and the heat generated during charge and discharge of the lithium battery 1000 may be more effectively dissipated to the outside of the battery 1000.

Referring to FIGS. 1 and 11A, the corrugated portion 510 includes the plurality of protrusions 511, and a distance D4 between adjacent ones of the plurality of protrusions 511 may be 5% or less, 3% or less, or 1% or less of the second distance D2 between the upper surface portion 300 and the lower surface portion 400. In an embodiment, the corrugated portion 510 includes the plurality of protrusions 511, and the distance D4 between adjacent ones of the plurality of protrusions 511 may be 10 mm or less, 5 mm or less, 1 mm or less, 100 micrometers (μm) or less, or 10 μm or less of the second distance D2 between the upper surface portion and the lower surface portion 400. When the distance D4 between adjacent ones of the protrusions is within the disclosed ranges, the volume change in the thickness direction (z direction in FIGS. 1 and 9A) of the unit cell stack 200 during charge and discharge of the lithium battery 1000 may be more effectively tolerated, and the increase in interfacial resistance between a solid electrolyte layer and an electrode may be suppressed, and heat generated during charge and discharge of the lithium battery 1000 may be more effectively dissipated to the outside of the lithium battery 1000.

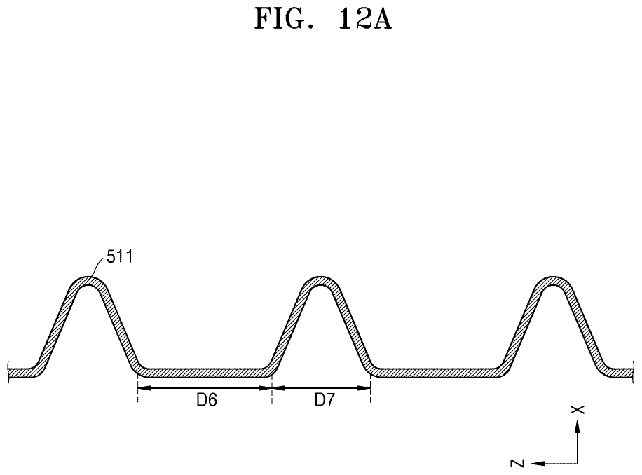

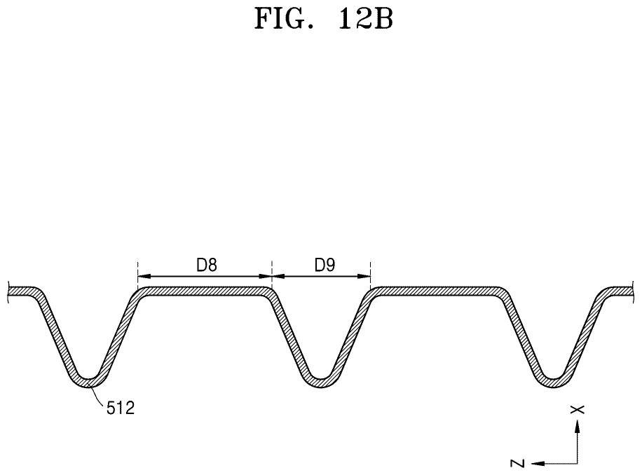

Referring to FIGS. 1 and 12A, the plurality of protrusions 511 may be spaced apart from each other in the thickness direction of the unit cell stack 200. A distance D6 between adjacent ones of the plurality of protrusions 511 may be 100% or greater, 110% or greater, 120% or greater, 150% or greater, or 200% or greater of a distance D7 between the opposite ends of one of the plurality of protrusions 511. When the distance D6 between adjacent ones of the plurality of protrusions 511 is within the disclosed range, and heat generated during charge and discharge of the lithium battery 1000 may be more effectively dissipated to the outside of the lithium battery 1000.

Referring to FIGS. 1 and 11B, the corrugated portion 510 includes the plurality of depressions 512, and a distance D5 between adjacent ones of the plurality of depressions 512 may be 5% or less, 3% or less, or 1% or less of the second distance D2 between the upper surface portion 300 and the lower surface portion 400. In an embodiment, the corrugated portion 510 includes the plurality of depressions 512, and the distance D5 between adjacent ones of the plurality of depressions 512 may be 10 mm or less, 5 mm or less, and 1 mm or less, 100 μm or less, or 10 μm or less. When the distance D5 between adjacent ones of the plurality of depressions 512 is within the disclosed ranges, the volume change in the thickness direction (z direction in FIGS. 1 and 9A) of the unit cell stack 200 during charge and discharge of the lithium battery 1000 may be more effectively tolerated, and the increase in interfacial resistance between a solid electrolyte layer and an electrode may be suppressed, and the heat generated during charge and discharge of the lithium battery 1000 may be more effectively dissipated to the outside of the lithium battery 1000.

Referring to FIGS. 1 and 12B, the plurality of depressions 512 may be spaced apart from each other in the thickness direction of the unit cell stack 200. A distance D8 between adjacent ones of the plurality of depressions 512 may be 100% or greater, 110% or greater, 120% or greater, 150% or greater, or 200% or greater of a distance D9 between the opposite ends of one of the plurality of depressions 512. When the distance D8 between adjacent ones of the plurality of depressions 512 is within the disclosed ranges, and heat generated during charge and discharge of the lithium battery 1000 may be more effectively dissipated to the outside of the lithium battery 1000.

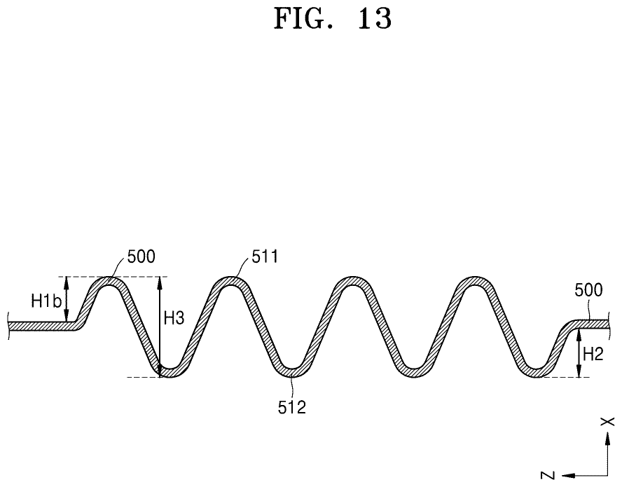

Referring to FIGS. 1 and 13, a height H1 between the highest point of the plurality of protrusions 511 and the surface of the side portion 500 adjacent to the plurality of protrusions 511 may be 5% or less, 3% or less, or 1% or less of the second distance D2 between the upper surface portion 300 and the lower surface portion 400. In an embodiment, the height H1 between the highest point of the plurality of protrusions 511 and the surface of the side portion 500 adjacent to the plurality of protrusions 511 may be 5 mm or less, 1 mm or less, 500 μm or less, or 100 μm or less. When the height H1 between the highest point of the plurality of protrusions 511 and the surface of the side portion 500 adjacent to the plurality of protrusions 511 is within the disclosed ranges, the volume change in the thickness direction (z direction in FIGS. 1 and 11) of the unit cell stack 200 during charge and discharge of the lithium battery 1000 may be tolerated, the increase in interfacial resistance between a solid electrolyte layer and an electrode may be suppressed, and heat generated during charge and discharge of the lithium battery 1000 may be effectively dissipated to the outside of the lithium battery 1000.

Referring to FIGS. 1 and 13, a height H2 between the lowest point of the plurality of depressions 512 and the surface of the side portion 500 adjacent to the plurality of depressions 512 may be 5% or less, 3% or less, or 1% or less of the second distance D2 between the upper surface portion 300 and the lower surface portion 400. In an embodiment, the height H2 between the lowest point of the plurality of depressions 512 and the surface of the side portion 500 adjacent to the plurality of depressions 512 may be 5 mm or less, 1 mm or less, 500 μm or less, or 100 μm or less. When the height H2 between the lowest point of the plurality of depressions 512 and the surface of the side portion 500 adjacent to the plurality of depressions 512 is within the disclosed ranges, the volume change in the thickness direction (z direction in FIGS. 1 and 11) of the unit cell stack 200 during charge and discharge of the lithium battery 1000 may be tolerated, the increase in interfacial resistance between a solid electrolyte layer and an electrode may be suppressed, and heat generated during charge and discharge of the lithium battery 1000 may be effectively dissipated to the outside of the lithium battery 1000.

Referring to FIGS. 1 and 13, a height H3 between the highest point of the plurality of protrusions 511 and the lowest point of the plurality of depressions 512 may be 0% or less, 6% or less, or 2% or less of the second distance D2 between the upper surface portion 300 and the lower surface portion 400. In an embodiment, the height H3 between the highest point of the plurality of protrusions 511 and the lowest point of the plurality of depressions 512 may be 10 mm or less, 5 mm or less, 1 mm or less, 500 μm or less, or 100 μm or less. When the height H3 between the highest point of the plurality of protrusions 511 and the lowest point of the plurality of depressions 512 is within the disclosed ranges, the volume change in the thickness direction (z direction in FIGS. 1 and 11) of the unit cell stack 200 during charge and discharge of the lithium battery 1000 may be tolerated, the increase in interfacial resistance between a solid electrolyte layer and an electrode may be suppressed, and heat generated during charge and discharge of the lithium battery 1000 may be effectively dissipated to the outside of the lithium battery 1000.

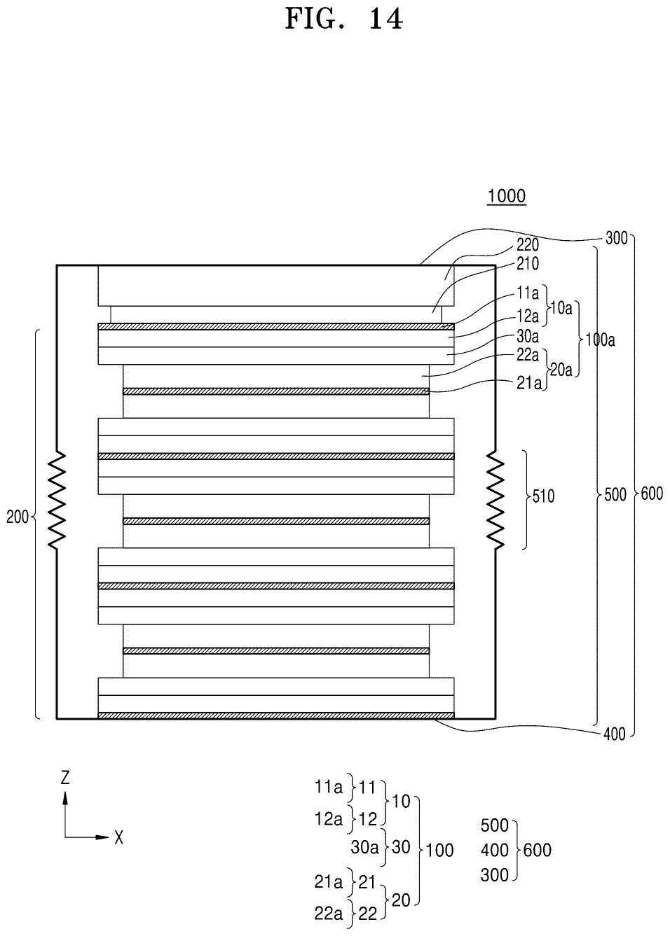

Referring to FIG. 14, the lithium battery 1000 may further include, for example, an elastic member 220 disposed between the upper surface portion 300 of the battery case 600 and the unit cell stack 200, in addition to the corrugated portion 510 disposed on the side portion 500 of the battery case 600. By further including the elastic member 220, the volume change in the thickness direction of the unit cell stack 200 during charge and discharge of the lithium battery 1000 may be more effectively tolerated. The corrugated portion 510 disposed on the side portion 500 of the battery case 600 already may have elasticity, and the elastic member 220 may function to provide auxiliary elasticity, additional elasticity, or a combination thereof to the lithium battery 1000. The elastic member 220 may be omitted, for example.

The elastic member 220 may be, for example, a polymer-based member. The elastic member 220 may be, for example, porous polymer foam, porous polymer sponge, rubber, etc., and is not necessarily limited thereto, and may be any suitable material that has elasticity and resilience. A polymer-based elastic member may be, for example, in the form of a porous sheet. A polymer-based elastic member may include, for example, a conductor including a conductive material or a non-conductor that does not include a conductive material. In an embodiment, the elastic member 220 may include a metal- based member. Metal-based members include, for example, stainless steel (“SUS”), copper (Cu), nickel (Ni), aluminum (Al), indium (In), magnesium (Mg), titanium (Ti), iron (Fe), cobalt (Co), zinc (Zn), germanium (Ge), or an alloy thereof. The metal-based member may be, for example, in the form of a spring washer. The metal-based member may be, for example, a conductor.

Referring to FIG. 14, the lithium battery 1000 may further include, for example, a spacer 210 disposed between the elastic member 220 and the unit cell stack 200. The spacer 210 functions to uniformly distribute the pressure applied by the elastic member 220 on the unit cell stack 200. The spacer 210 may be selected, for example, from metal- based members used in the elastic member 220. The spacer 210 may be, for example, in the form of a conductive sheet. The spacer 210 may be omitted, for example.

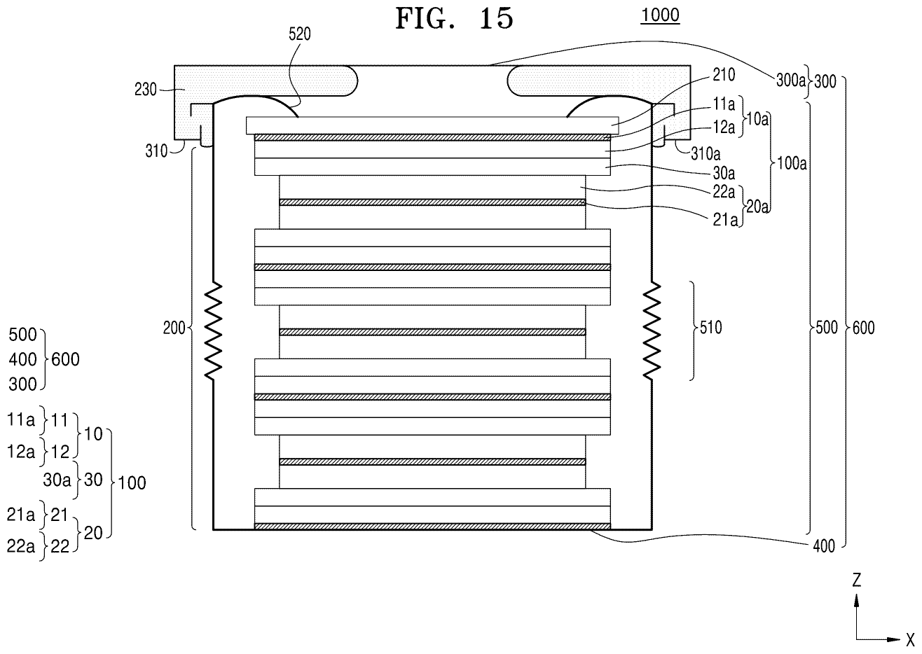

Referring to FIG. 15, the lithium battery 1000 may further include, in addition to the corrugated portion 510, a first curved portion 520 that extends from the side portion 500 of the battery case 600 and supports the upper end surface of the unit cell stack 200. The battery case 600 may further include the first curved portion 520 in addition to the corrugated portion 510, and additional pressure may be provided to the unit cell stack 200. The battery case 600 may further include the first curved portion 520 in addition to the corrugated portion 510, and the volume change in the thickness direction of the unit cell stack 200 (z direction in FIG. 15) during charge and discharge of the lithium battery 1000 may be more effectively tolerated. By additionally pressing the unit cell stack 200 by the first curved portion 520, an increase in the interfacial resistance between a solid electrolyte layer and an electrode due to change in volume of the unit cell stack 200 may be more effectively suppressed. For example, the first curved portion 520 may be curved from the side portion 500 of the battery case 600 toward the inside of the battery case 600. The first curved portion 520 may function like a plate spring, for example. The first curved portion 520 may formed integrally with the side portion 500 of the battery case 600, and additional pressure may be provided more uniformly to the unit cell stack 200 together with the corrugated portion 510 of the side portion 500 of the battery case 600, without a separate elastic member. A distal end of the first curved portion 520 may support the upper end surface of the unit cell stack 200. The distal end of the first curved portion 520 may apply a certain pressure to the upper end surface of the unit cell stack 200. The first curved portion 520 may provide elastic force in the thickness direction of the unit cell stack 200. The first curved portion 520 may include a metal-based material or may be formed of a metal-based material. Metal-based materials include, for example, stainless steel (“SUS”), copper (Cu), nickel (Ni), aluminum (Al), indium (In), magnesium (Mg), titanium (Ti), iron (Fe), cobalt (Co), zinc (Zn), germanium (Ge), or an alloy thereof. The first curved portion 520 may have increased elasticity compared to other areas constituting the side portion 500 through, for example, heat treatment.

Referring to FIG. 15, the lithium battery 1000 may further include a spacer 210 disposed between the first curved portion 520 and the unit cell stack 200. The spacer 210 may function to uniformly distribute the pressure applied by the first curved portion 520 on the unit cell stack 200. The spacer 210 may be, for example, a metal member. The spacer 210 may be, for example, in the form of a conductive sheet.

Referring to FIG. 15, the lithium battery 1000 may include the upper surface portion 300, and the upper surface portion 300 may be a first cap assembly 300a. The first cap assembly 300a accommodates the first curved portion 520 and is electrically insulated from the side portion 500. The first cap assembly 300a may include a fastening portion 310a coupled to the side portion 500 via an insulator 230. The first cap assembly 300a may be fastened to the side portion 500 via the insulator 230 by the fastening portion 310a to seal the lithium battery 1000. The first electrode or the second electrode may be electrically connected to the upper surface portion 300 of the battery case 600, that is, the first cap assembly 300a, and the second electrode or the first electrode may be electrically connected to the side portion 500, the lower surface portion 400, or a combination thereof of the battery case 600. The upper surface portion 300 of the battery case 600 may be electrically insulated from the side portion 500, the lower surface portion 400, or a combination thereof of the battery case 600 by the insulator 230.

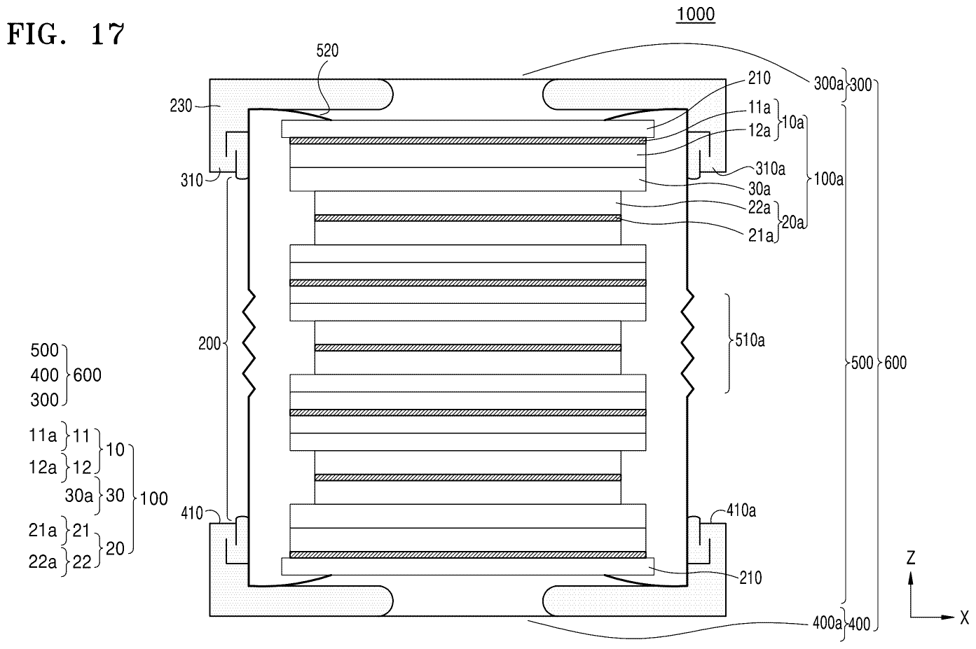

Referring to FIG. 16, the lithium battery 1000 may further include, in addition to the corrugated portion 510, a first curved portion 520 that extends from the side portion 500 of the battery case 600 and supports the upper end surface of the unit cell stack 200, and a second curved portion 530 supporting the lower end surface of the unit cell stack 200. The battery case 600 may further include the first curved portion 520 and the second curved portion 530, in addition to the corrugated portion 510, and additional pressure may be provided to the unit cell stack 200. The battery case 600 may further include the first curved portion 520 and the second curved portion 530, in addition to the corrugated portion 510, and the volume change in the thickness direction (z direction in FIG. 16) of the unit cell stack 200 during charge and discharge of the lithium battery 1000 may be more effectively tolerated. The first curved portion 520 and the second curved portion 530 may additionally press the unit cell stack 200 in opposite directions, and the increase in the interfacial resistance between a solid electrolyte layer and an electrode due to change in volume of the unit cell stack 200 may be more effectively suppressed. For example, the second curved portion 530 may be curved from the side portion 500 of the battery case 600 toward the inside of the battery case 600. In an embodiment, the second curved portion 530 may function like a plate spring. The second curved portion 530 may be integrally formed with the side portions 500 of the battery case 600, and additional pressure may be more uniformly provided to the unit cell stack 200 together with the corrugated portion 510 of the side portion 500 of the battery case 600, without a separate elastic member. The distal end of the second curved portion 530 may support the lower end surface of the unit cell stack 200. The distal end of the second curved portion 530 may apply a certain pressure to the lower end surface of the unit cell stack 200. The second curved portion 530 may provide elastic force in the thickness direction of the unit cell stack 200. The second curved portion 530 may include a metal-based material or may be formed of a metal-based material. Metal-based materials may include, for example, stainless steel (“SUS”), copper (Cu), nickel (Ni), aluminum (Al), indium (In), magnesium (Mg), titanium (Ti), iron (Fe), cobalt (Co), zinc (Zn), germanium (Ge), or an alloy thereof. The second curved portion 530 may have increased elasticity compared to other areas constituting the side portion 500 through, for example, heat treatment.

Referring to FIG. 16, the lithium battery 1000 may further include a spacer 210 disposed between the second curved portion 530 and the unit cell stack 200. The spacer 210 may function to uniformly distribute the pressure applied by the second curved portion 530 on the unit cell stack 200. The spacer 210 may be, for example, a metal-based member. The spacer 210 may be, for example, in the form of a conductive sheet.

Referring to FIG. 16, the lithium battery 1000 may include the upper surface portion 300 and the lower surface portion 400, wherein the upper surface portion 300 may be the first cap assembly 300a and the lower surface portion 400 may be a second cap assembly 400a. The first cap assembly 300a accommodates the first curved portion 520 and is electrically insulated from the side portion 500. The second cap assembly 400a accommodates the second curved portion 530 and is electrically insulated from the side portion 500. The first cap assembly 300a and the second cap assembly 400a may respectively include fastening portions 310 and 410 that are fastened to the insulator 230 via the side portion 500. The first cap assembly 300a and the second cap assembly 400a are coupled to the side portion 500 via the insulator 230 by the fastening portions 310a and 410a to seal the lithium battery 1000. The first electrode or the second electrode may be electrically connected to the upper surface portion 300 of the battery case 600, that is., the first cap assembly 300a, and the second electrode or the first electrode may be electrically connected to the lower surface portion 400 of the battery case 600, that is, the second cap assembly 400a. The upper surface portion 300 and the lower surface portion 400 of the battery case 600 may be electrically insulated from the side portion 500 of the battery case 600 by the insulator 230.

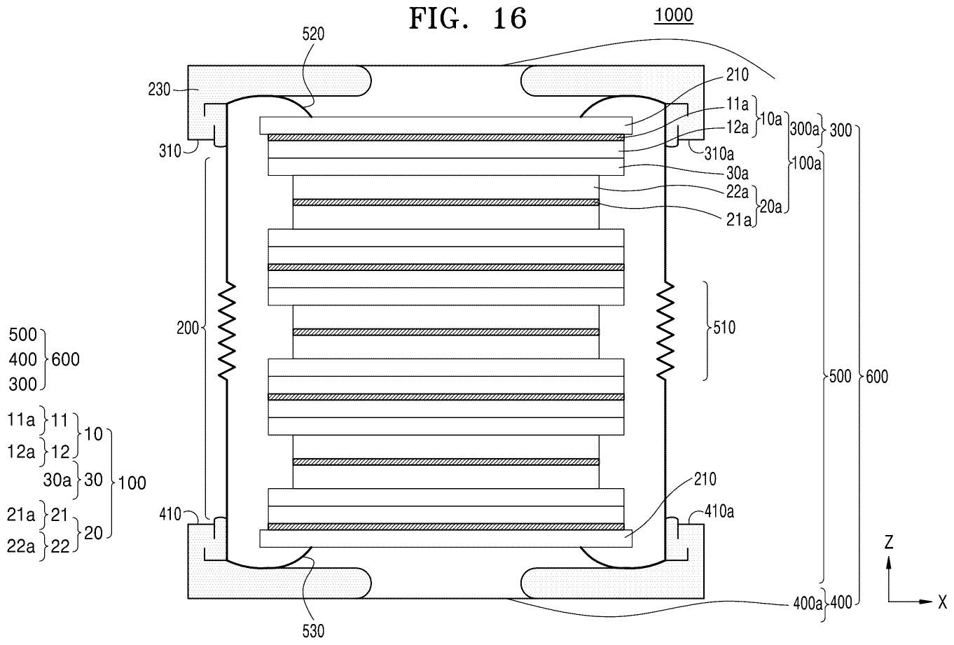

Referring to FIG. 17, as the volume of the unit cell stack 200 is increased during the charging and discharging process of the lithium battery 1000, the degree of bending of the first curved portion 520 and the second curved portion 530 may be decreased, and the distance between opposite ends of the corrugated portion 510 may be increased. Referring to FIG. 16, as the volume of the unit cell stack 200 is decreased during the charging and discharging process of the lithium battery 1000, the degree of bending of the first curved portion 520 and the second curved portion 530 may be increased and the distance between opposite ends of the corrugated portion 510 may be decreased. The lithium battery 1000 may include the corrugated portion 510, the first curved portion 520, and the second curved portion 530, the volume change in the thickness direction (z direction in FIGS. 16 and 17) of the unit cell stack 200 during charge and discharge of the lithium battery 1000 may be more effectively tolerated, heat generated during charge and discharge of the lithium battery 1000 may be more effectively dissipated to the outside of the lithium battery 1000, and the increase in the interfacial resistance between a solid electrolyte layer and an electrode due to change in the volume of the stack 200 may be more effectively suppressed.

### Lithium Battery: Cathode Active Material Layer

Referring to FIGS. 1 to 2, 5 to 8, and 14 to 17, the first electrode active material layer 12 or 12a or the second electrode active material layer 22 or 22a may be, for example, a cathode active material layer.

The cathode active material may be, for example, a lithium transition metal oxide, a transition metal sulfide, etc. For example, a composite oxide of lithium and a metal of cobalt, manganese, nickel, or a combination thereof may be used, and a specific example thereof is a compound represented by any of the following formulae: LiₐA_{1-b}B′_{b}D′₂ where 0.90≤a≤1.8, and 0≤b≤0.5; LiₐE_{1-b}B′_{b}O_{2-c}D′_{c} where 0.90≤a≤1.8, 0≤b≤0.5, and 0≤c≤0.05; LiE_{2-b}B′_{b}O_{4-c}D′_{c} where 0≤b≤0.5, and 0≤c≤0.05; LiₐNi_{1-b-c}CO_{b}B′_{c}D′_{α} where 0.90≤a≤1.8, 0≤b≤0.5, 0≤c≤0.05, and 0<α≤2; LiₐNi_{1-b-c}CO_{b}B′_{c}O_{2-α}F′_{α} where 0.90≤a≤1.8, 0≤b≤0.5, 0≤c≤0.05, and 0<α<2; LiₐNi_{1-b-c}Co_{b}B′_{c}O_{2-α}F′₂ where 0.90≤a≤1.8, 0≤b≤0.5, 0≤c≤0.05, and 0<α<2; LiₐNi_{1-b-c}Mn_{b}B′_{c}D′_{α} where 0.90≤a≤1.8, 0≤b≤0.5, 0≤c≤0.05, and 0<α≤2; LiₐNi_{1-b-c}Mn_{b}B′_{c}O_{2-α}F′_{α} where 0.90≤a≤1.8, 0≤b≤0.5, 0≤c≤0.05, and 0<α<2; LiₐNi_{1-b-c}Mn_{b}B′_{c}O_{2-α}F′₂ where 0.90≤a≤1.8, 0≤b≤0.5, 0≤c≤0.05, and 0<α<2; LiₐNi_{b}E_{c}G_{d}O₂ where 0.90≤a≤1.8, 0≤b≤0.9, 0≤c≤0.5, and 0.001≤d≤0.1; LiₐNi_{b}Co_{c}Mn_{d}GeO₂ where 0.90≤a≤1.8, 0≤b≤0.9, 0≤c≤0.5, 0≤d≤0.5, and 0.001≤e≤0.1; LiₐNiG_{b}O₂ where 0.90≤a≤1.8, and 0.001≤b≤0.1; LiₐCoG_{b}O₂ where 0.90≤a≤1.8, and 0.001≤b≤0.1; LiₐMnG_{b}O₂ where 0.90≤a≤1.8, and 0.001≤b≤0.1; LiₐMn₂G_{b}O₄ where 0.90≤a≤1.8, and 0.001≤b≤0.1; QO₂; QS₂; LiQS₂; V₂O₅; LiV₂O₂; Lil′O₂; LiNiVO₄; Li_{(3-f)}J₂(PO₄)₃(0≤f≤2); Li_{(3-f)}Fe₂(PO₄)₃(0≤f≤2); and LiFePO₄. In the disclosed formulae, A may be Ni, Co, Mn, or a combination thereof; B′ may be Al, Ni, Co, Mn, Cr, Fe, Mg, Sr, V, a rare earth element, or a combination thereof; D′ may be O, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof. For example, LiCoO₂, LiMnₓO₂ₓ(x=1, 2), LiNi₁₋ₓMnₓO₂ₓ(0<x<1), Ni_{1-x-y}CoₓMn_{y}O₂ (0≤x≤0.5, 0≤y≤0.5), LiFePO₄, TiS₂, FeS₂, TiS₃, or FeS₃ may be used.

For example, the cathode active material may be a compound represented by Formulae 1 to 8.

LiₐCoₓM_{y}O_{2-b}A_{b} Formula 1

wherein, in Formula 1,
1.0≤a≤1.2, 0≤b≤0.2, 0.9≤x≤1, 0≤y≤0.1, and x+y=1,
M may be manganese (Mn), niobium (Nb), vanadium (V), magnesium (Mg), gallium (Ga), silicon (Si), tungsten (W), molybdenum (Mo), iron (Fe), chromium (Cr)), copper (Cu), zinc (Zn), titanium (Ti), aluminum (Al), boron (B), or a combination thereof, and
A may be F, S, Cl, Br, or a combination thereof,

LiₐNiₓCo_{y}M_{z}O_{2-b}A_{b} Formula 2

wherein, in Formula 2,
1.0≤a≤1.2, 0≤b≤0.2, 0.8≤x<1, 0≤y≤0.3, 0<z≤0.3, and x+y+z=1,
M may be manganese (Mn), niobium (Nb), vanadium (V), magnesium (Mg), gallium (Ga), silicon (Si), tungsten (W), molybdenum (Mo), iron (Fe), chromium (Cr)), copper (Cu), zinc (Zn), titanium (Ti), aluminum (Al), boron (B), or a combination thereof, and
A may be F, S, Cl, Br, or a combination thereof,

LiNiₓCO_{y}Mn_{z}O₂, Formula 3

LiNiₓCo_{y}Al_{z}O₂ Formula 4

wherein, in Formulae 3 to 4, 0.8≤x≤0.95, 0≤y≤0.2, 0<z≤0.2, and x+y+z=1,

LiNiₓCo_{y}Mn_{z}Al_{w}O₂ Formula 5

wherein, in Formula 5, 0.8≤x≤0.95, 0≤y≤0.2, 0<z≤0.2, 0<w≤0.2, and x+y+z+w=1,

LiₐNiₓMn_{y}M′_{z}O_{2-b}A_{b} Formula 6

wherein, in Formula 6,
1.0≤a≤1.2, 0≤b≤0.2, 0<x≤0.3, 0.5≤y<1, 0<z≤0.3, and x+y+z=1,
M′ may be cobalt (Co), niobium (Nb), vanadium (V), magnesium (Mg), gallium (Ga), silicon (Si), tungsten (W), molybdenum (Mo), iron (Fe), chromium (Cr)), copper (Cu), zinc (Zn), titanium (Ti), aluminum (Al), boron (B), or a combination thereof, and
A may be F, S, Cl, Br, or a combination thereof,

LiₐM1ₓM2_{y}PO_{4-b}X_{b} Formula 7

wherein, in Formula 7, 0.90≤a≤1.1, 0≤x≤0.9, 0≤y≤0.5, 0.9<x+y<1.1, and 0≤b≤2,
M1 may be chromium (Cr), manganese (Mn), iron (Fe), cobalt (Co), nickel (Ni), copper (Cu), zirconium (Zr), or a combination thereof, and
M2 is magnesium (Mg), calcium (Ca), strontium (Sr), barium (Ba), titanium (Ti), zinc (Zn), boron (B), niobium (Nb), gallium (Ga), and indium (In), molybdenum (Mo), tungsten (W), aluminum (Al), silicon (Si), chromium (Cr), vanadium (V), scandium (Sc), yttrium (Y), or a combination thereof, and, F, S, P or a combination thereof.

LiₐM3_{z}PO₄ Formula 8

wherein, in Formula 8, 0.90≤a≤1.1 and 0.9≤z≤1.1, and
M3 may be chromium (Cr), manganese (Mn), iron (Fe), cobalt (Co), nickel (Ni), copper (Cu), zirconium (Zr), or a combination thereof.

The cathode active material layer may further include a conductive material and a binder.

The conductive material may include, for example, carbon black, carbon fiber, graphite, or a combination thereof. The carbon black may be, for example, acetylene black, Ketjen black, Super P carbon, channel black, furnace black, lamp black, thermal black, or a combination thereof. Graphite may be natural graphite or artificial graphite. Combinations including at least one conductive material materials may be used. The cathode active material layer may additionally include an additional conductive agent other than the carbonaceous conductive agent described herein. The additional conductive agent may include electrically conductive fibers such as metal fibers; metal powders such as fluorinated carbon powder, aluminum powder or nickel powder; conductive whiskers such as zinc oxide or potassium titanate; or a polyethylene derivative. Combinations including at least one additional conductive agent described herein may be used. The content of the conductive material may be about 1 to about 10 parts by weight, or about 2 to about 7 parts by weight, based on 100 parts by weight of the cathode active material. When the amount of the conductive material is within the disclosed ranges, for example, about 1 part by weight to about 10 parts by weight, the electrical conductivity of the cathode active material layer may be appropriate.

A binder may improve the adhesion between components of the cathode active material layer and the adhesion to the current collecting member of the cathode active material layer. Examples of binders include polyacrylic acid (“PAA”), polyvinylidene fluoride, polyvinyl alcohol, carboxymethyl cellulose (“CMC”), starch, hydroxypropyl cellulose, regenerated cellulose, polyvinylpyrrolidone, tetrafluoroethylene, polyethylene, polypropylene, ethylene-propylene-diene monomer (“EPDM”), sulfonated EPDM, styrene-butadiene-rubber, fluorinated rubber, copolymers thereof, or a combination thereof. The content of the binder may be about 1 to about 10 parts by weight, or about 2 to about 7 parts by weight, based on 100 parts by weight of the cathode active material. When the content of the binder is within the disclosed ranges, and the adhesion of the cathode active material layer to the current collecting member may be further improved and a decrease in energy density of the cathode active material layer may be suppressed.

### Lithium Battery: Electrolyte Layer

Referring to FIGS. 1 to 2, 5 to 8, and 14 to 17, an electrolyte layer may include a solid electrolyte, a liquid electrolyte, or a combination thereof.

The thickness of the electrolyte layer may be, for example, 500 μm or less, 300 μm or less, 100 μm or less, or 50 μm or less. The thickness of an electrolyte layer 30 may be, for example, about 1 μm to about 500 μm, about 5 μm to about 300 μm, about 5 μm to about 100 μm, or about 5 μm to about 50 μm.

The electrolyte layer may have a multilayer structure including, for example, a solid electrolyte layer and a liquid electrolyte layer. The electrolyte layer may have a two-layer structure of, for example, a solid electrolyte layer/liquid electrolyte layer.

### Solid Electrolyte Layer

The electrolyte layer may be, for example, a solid electrolyte layer.

The solid electrolyte layer may include, for example, an oxide-based solid electrolyte, a sulfide-based solid electrolyte, a halide-based solid electrolyte, or a combination thereof.

The solid electrolyte layer may be, for example, liquid impermeable, and in a lithium battery in which a cathode active material layer includes a cathode electrolyte, the cathode electrolyte may not penetrate the solid electrolyte layer.

Oxide-based solid electrolytes may include, for example, lithium phosphorus oxynitride (“LiPON”), Li₃ₓLa_{(2/3-x)(1/3-2x)}TiO₃ (0.04<x<0.16), Li₁₊ₓAlₓTi₂₋ₓ(PO₄)₃(0<x<2), Li₁₊ₓAlₓGe₂₋ₓ(PO₄)₃(0<x<2), Li_{1+x+y}AlₓTi₂₋ₓSi_{y}P_{3-y}O₁₂ (0<x<2, 0≤y<3), BaTiO₃, Pb(Zr, Ti)O₃, Pb₁₋ₓLaₓZr_{1-y}Ti_{y}O₃ (0≤x<1, 0≤y<1), Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (O≤x≤1 0≤y≤1), LiₓLa_{y}TiO₃(0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M is Te, Nb, or Zr, 1≤x≤10), Li₇La₃Zr₂O₁₂, Li₃₊ₓLa₃Zr₂₋ₐMₐO₁₂, (M is Ga, W, Nb, Ta, or Al, and 0<a<2, 1≤x≤10) or a combination thereof. The solid electrolyte may be manufactured by, for example, a sintering method. Oxide-based solid electrolytes may be, for example, a Garnet-type solid electrolyte of Li₇La₃Zr₂O₁₂ (“LLZO”) or Li₃₊ₓLa₃Zr₂₋ₐMₐO₁₂ (“M doped LLZO”, M═Ga, W, Nb, Ta, or Al, 0<a<2, 1≤x≤10)

The oxide-based solid electrolyte may be, for example, crystalline, amorphous, glassy, or glass-ceramic. Oxide-based solid electrolytes may have various crystal states depending on the manufacturing method and composition.

The sulfide-based solid electrolyte may include, for example, lithium sulfide, silicon sulfide, phosphorus sulfide, boron sulfide, or a combination thereof. The sulfide-based solid electrolyte particles may include Li₂S, P₂S₅, SiS₂, GeS₂, B₂S₃, or a combination thereof. The sulfide-based solid electrolyte particles may be Li₂S or P₂S₅. Sulfide-based solid electrolyte particles are known to have higher lithium ion conductivity than other inorganic compounds. For example, sulfide-based solid electrolytes include Li₂S and P₂S₅. When the sulfide solid electrolyte material constituting the solid electrolyte includes Li₂S—P₂S₅, the mixing molar ratio of Li₂S to P₂S₅ may range from about 50:50 to about 90:10, for example. Sulfide-based solid electrolytes may also include an inorganic solid electrolyte prepared by adding Lip₃PO₄, halogen, halogen compounds, Li₂₊₂ₓZn₁₋ₓGeO₄ (“LISICON”), Li_{3+y}PO₄₋ₓNₓ (“LIPON”), Li_{3.25}Ge_{0.25}P_{0.75}S₄ (“Thio-LISICON”), Li₂O—Al₂O₃—TiO₂—P₂O₅ (“LATP”), etc., to an inorganic solid electrolyte of Li₂S—P₂S₅, SiS₂, GeS₂, B₂S₃, or a combination thereof. Non-limiting examples of sulfide solid electrolyte materials include Li₂S—P₂S₅; Li₂S—P₂S₅—LiX (X is a halogen element); Li₂S—P₂S₅—Li₂O; Li₂S—P₂S₅—Li₂O—Lil; Li₂S—SiS₂; Li₂S—SiS₂—Lil; Li₂S—SiS₂—LiBr; Li₂S—SiS₂—LiCl; Li₂S—SiS₂—B₂S₃—Lil; Li₂S—SiS₂—P₂S₅—Lil; Li₂S—B₂S₃; Li₂S—P₂S₅—ZmSn (m and n are positive numbers, and Z is Ge, Zn, or G); Li₂S—GeS₂; Li₂S—SiS₂—Li₃PO₄; and Li₂S—SiS₂—LiₚMO_{q} (where p and q are positive numbers, and M is P, Si, Ge, B, Al, Ga, or In). The sulfide- based solid electrolyte material is manufactured by treating the raw starting materials (e.g., Li₂S, P₂S₅, etc.) of the sulfide-based solid electrolyte material by a melt quenching method, a mechanical milling method, etc. In an embodiment, calcinations may be performed after the treatment.

Halide-based solid electrolytes include, for example, a halogen element as a main component of anions. Including a halogen element as a main component of an anion refers to the ratio (molar ratio) of the halogen element being the largest among all the anions constituting a halide solid electrolyte. The ratio of the halogen (X) element to all anions constituting the halide solid electrolyte may be, for example, 50 mol % or greater, 70 mol % or greater, 90 mol % or greater, or 100 mol %. One or more halogen elements may be used. The halide solid electrolyte may not include sulfur element (S element), for example. The halide solid electrolyte may include, for example, Li element, M element (M is a metal other than Li), and X element. X may be, for example, F, Cl, Br, I or a combination thereof. The halide solid electrolyte may include, for example, Br or Cl as X. In an embodiment, the halide solid electrolyte may include, as M, metal elements such as Sc, Y, B, Al, Ga, and In. The composition of the halide solid electrolyte may be, for example, Li₆₋₃ₐMₐBr_{b}Cl_{c} (M is a metal other than Li, 0<a<2, 0≤b≤6, 0≤c≤6, and b+c=6). The halide solid electrolyte may be, for example, Li₃YBr₆, Li₃YCl₆, Li₃YBr₂C₁₄, etc. The halide solid electrolyte may be, for example, particulate. The average particle diameter (D50) of the halide solid electrolyte may be, for example, about 0.05 μm to about 50 μm, or about 0.1 μm to about 20 μm. The average particle diameter (D50) of the halide solid electrolyte may be measured using, for example, a laser diffraction particle size distribution meter or a scanning electron microscope (“SEM”).

The solid electrolyte layer may be provided, for example, in the form of a solid electrolyte sheet or a solid electrolyte thin film. In an embodiment, the solid electrolyte layer may be manufactured by mixing the solid electrolyte with other components.

The solid electrolyte layer may be manufactured, for example, by mixing and drying the solid electrolyte described herein and the binder, or by pressing, sintering, or a combination thereof powder of the solid electrolyte described herein into a certain shape. The solid electrolyte layer is manufactured, for example, by mixing and drying a sulfide-based, oxide-based, halide-based, or a combination thereof solid electrolyte with a binder, or by pressing, sintering, or a combination thereof powder of a sulfide-based, oxide-based, halide-based or a combination thereof solid electrolyte into a certain form.

The solid electrolyte may be deposited using, for example, a film formation method using blasting, aerosol deposition, cold spraying, sputtering, chemical vapor deposition (“CVD”), or spraying, and a solid electrolyte layer may be manufactured using the same. In an embodiment, the solid electrolyte layer may be formed by pressing the solid electrolyte. In an embodiment, the solid electrolyte layer may be formed by mixing and pressing a solid electrolyte, a solvent, and a binder or a support. In this case, a solvent or support is added to reinforce the strength of the solid electrolyte layer or to prevent short-circuiting of the solid electrolyte.

The binder included in the solid electrolyte layer may be, for example, styrene butadiene rubber (“SBR”), polytetrafluoroethylene, polyvinylidene fluoride, polyethylene, or polyvinyl alcohol. However, the binder is not limited thereto, and may be any suitable binder. The binder of the solid electrolyte layer may be the same as or different from the binder of a cathode, an anode, or a combination thereof.

### Liquid Electrolyte Layer

A liquid electrolyte layer may include, for example, an organic electrolyte solution. In an embodiment, the organic liquid electrolyte may be prepared by dissolving a lithium salt in an organic solvent.

Any suitable organic solvent may be used as the organic solvent herein. The organic solvent may be, for example, propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N, N-dimethylformamide, dimethylacetamide, dimethylsulfoxide, dioxane, 1,2-dimethoxyethane, sulfolane, dichloroethane, chlorobenzene, nitrobenzene, diethylene glycol, dimethylether, or a combination thereof.

Any suitable lithium salt may be used. The lithium salts may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are each the natural number of 1 to 20), LiCl, Lil, or a combination thereof.

### Lithium Battery: Anode Active Material Layer

Referring to FIGS. 1 to 2, 5 to 8, and 14 to 17, the first electrode active material layer 12 or 12a or the second electrode active material layer 22 or 22a may be, for example, an anode active material layer.

### Anode Active Material Layer Including Lithium Metal

For example, the anode active material layer may include, as an anode active material, lithium metal, lithium alloy, or a combination thereof. Lithium metal, lithium alloy, or a combination thereof may be included as the anode active material, and a binder and a conductive material may not be included.

The anode active material layer may include, for example, lithium foil, lithium powder, plated lithium, lithium alloy, or a combination thereof. The anode active material layer including lithium foil may be, for example, a lithium metal layer. The anode active material layer including lithium powder may be introduced by coating a slurry including lithium powder and a binder on an anode current collector. The binder may be, for example, a fluorine-based binder such as polyvinylidene fluoride (“PVDF”). The anode active material layer may not include a carbon-based anode active material, and the anode active material layer may include a metal-based anode active material. The anode active material layer may also be a plated lithium metal layer. Lithium alloys may include, for example, Li—Al alloy, Li—Sn alloy, Li—In alloy, Li—Ag alloy, Li—Au alloy, Li—Zn alloy, Li—Ge alloy, Li—Si alloy, etc., and are not limited thereto, and any suitable lithium alloy may be applicable herein. A lithium metal layer deposited between a current collecting member and an electrolyte layer during charge, after manufacturing a lithium battery by assembling an anode, a cathode, and the electrolyte without an anode active material layer, may be further included as an anode active material layer.

The thickness of the anode active material layer may be, for example, about 0.1 μm to about 100 μm, about 0.1 μm to about 80 μm, about 1 μm to about 80 μm, or about 10 μm to about 80 μm, and is not necessarily limited to the disclosed ranges, and may be adjusted according to the desired shape or capacity of a lithium battery. When the thickness of the anode active material layer is increased excessively, the structural stability of a lithium battery may be decreased and more side reactions may occur. When the thickness of the anode active material layer is too small, the energy density of a lithium battery may be decreased. The thickness of a lithium foil may be, for example, about 1 μm to about 50 μm, or about 1 μm to about 30 μm, or about 10 μm to about 30 μm, or about 10 μm to about 80 μm. When thickness of the lithium foil is within the disclosed ranges, the lifespan characteristics of a lithium battery including a protective layer may be further improved. The particle size of the lithium powder may be, for example, about 0.1 μm to about 3 μm, about 0.1 μm to about 2 μm, or about 0.1 μm to about 2 μm. When the size of the lithium powder is within the disclosed ranges, the lifespan characteristics of a lithium battery including a protective layer may be further improved. The thickness of the lithium precipitate layer may be, for example, about 1 μm to about 80 μm, or about 10 μm to about 80 μm.

Anode active material layer including carbon-based material, metal-based material, or a combination thereof

The anode active material layer may include, for example, an anode active material.

The anode active material may be any suitable anode active material for use as an anode active material for a lithium battery. For example, lithium metal, a lithium-alloyable metal, a transition metal oxide, a non-transition metal oxide, a carbon-based material, or a combination thereof, may be included. Examples of the lithium-alloyable metal include Si, Sn, Al, Ge, Pb, Bi, Sb, an Si—Y alloy (Y is an alkali metal, an alkali-earth metal, a Group 13 element, a Group 14 element, a transition metal, a rare earth element, or a combination thereof, not Si), and an Sn—Y alloy (Y is an alkali metal, an alkali-earth metal, a Group 13 element, a Group 14 element, a transition metal, a rare earth element, or a combination thereof, not Sn). The element Y may be, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. The transition metal oxide may be, for example, lithium titanium oxide, vanadium oxide, lithium vanadium oxide, and the like. Non-transition metal oxides may be, for example, SnO₂, SiOₓ (0<x<2), or the like. The carbon-based material may be, for example, crystalline carbon, amorphous carbon, or a combination thereof. Crystalline carbon may be, for example, graphite, such as natural or artificial graphite in an amorphous form, a platy form, a flake form, a spherical form, or a fibrous form. Amorphous carbon may be, for example, soft carbon (low-temperature calcined carbon) or hard carbon, mesophase pitch carbide, calcined coke, and the like.

The anode active material layer may further include a conductive material and a binder.

The conductive material and binder used in the anode active material layer may be a conductive material and binder as used in the cathode active material layer.

The content of the binder used in the anode active material layer may be, for example, about 0.1 weight percent (wt %) to about 10 wt % or about 0.1 wt % to about 5 wt % of the total weight of the anode active material layer. The content of the conductive material used in the anode active material layer may be, for example, about 0.1 wt % to about 10 wt % or about 0.1 wt % to about 5 wt % of the total weight of the anode active material layer. The content of the anode active material used in the anode active material layer may be, for example, about 80 wt % to about 99 wt %, about 90 wt % to about 99 wt %, or about 95 wt % to about 99 wt % of the total weight of the anode active material layer.

### Interlayer

A unit cell may further include an interlayer disposed between an electrolyte layer and a current collecting member. Due to the inclusion of an interlayer in the unit cell, the creation, growth, or a combination thereof of lithium dendrites between the anode active material layer and the electrolyte layer may be more effectively suppressed. The interlayer may be omitted. In an embodiment, the thickness of the interlayer may be smaller than the thickness of the electrolyte layer.

In an embodiment, the interlayer may include: a carbon-based material, a metal-based material, or a combination thereof; and a binder. The interlayer may not include an organic electrolyte.

Carbon-based materials and metal-based materials may be, for example, materials that may be lithiated and delithiated. The carbon-based material and the metal-based material included in the interlayer may have, for example, a particle form. The average particle diameter of the carbon-based material, metal-based material, or a combination thereof, which are in the particle form may be, for example, about 10 nanometers (nm) to about 4 um, about 10 nm to about 1 μm, about 10 nm to about 500 nm, about 10 nm to about 100 nm, or about 20 nm to about 80 nm. When an average particle size of the carbon-based material, the metal-based material, or a combination thereof has is within the disclosed ranges, reversible plating, dissolution, or a combination thereof of lithium during charge and discharge may be facilitated more easily. The average particle diameter of the carbon-based material, the metal-based material, or a combination thereof may be, for example, a median diameter (D50) measured using a laser particle size distribution meter.

The interlayer may include, for example, a carbon-based material, a metal-based material, or a combination thereof. The carbon-based material may be, for example, amorphous carbon. Carbon-based materials may include, for example, carbon black (“CB”), acetylene black (“AB”), furnace black (“FB”), ketjen black (“KB”), graphene, etc., but is not necessarily limited thereto, and any suitable amorphous carbon may be used. Amorphous carbon is carbon that does not have crystallinity or has very low crystallinity, and is distinguished from crystalline carbon or graphite-based carbon. The metallic material may be a metallic material or a metalloid material. Metallic materials may include, for example, gold (Au), platinum (Pt), palladium (Pd), silicon (Si), silver (Ag), aluminum (Al), bismuth (Bi), tin (Sn), zinc (Zn), or a combination thereof. For example, nickel (Ni) does not form an alloy with lithium and is not a metal-based material included in the interlayer in this specification. The interlayer may include a carbon-based material, a metal-based material, or a combination thereof. The interlayer may include, for example, amorphous carbon. The interlayer may be, for example, a mixture of amorphous carbon with gold (Au), platinum (Pt), palladium (Pd), silicon (Si), silver (Ag), aluminum (Al), bismuth (Bi), tin (Sn), zinc (Zn), or a combination thereof. The mixing ratio of the mixture is a weight ratio and may be, for example, 10:1 to 1:2, 10:1 to 1:1, 7:1 to 1:1, 5:1 to 1:1, or 4:1 to 2:1. The interlayer may include, for example, a mixture of a first particle including amorphous carbon and a second particle including a metal or metalloid. Metals may include, for example, gold (Au), platinum (Pt), palladium (Pd), silicon (Si), silver (Ag), aluminum (Al), bismuth (Bi), tin (Sn), and zinc (Zn). The content of the second particles may be about 8 wt % to about 60 wt %, about 10 wt % to about 50 wt %, about 15 wt % to about 40 wt %, or about 20 wt % to about 30 wt %, based on the total weight of the mixture. When the content of the second particles is within the disclosed ranges, for example, the cycle characteristics of a lithium battery may be further improved.

The binder that is included in the interlayer may include, for example, styrene-butadiene rubber (“SBR”), polytetrafluoroethylene, polyvinylidene fluoride, polyethylene, vinylidene fluoride/hexafluoropropylene co. It is not necessarily limited to polymer, polyacrylonitrile, polymethyl methacrylate, etc., and any suitable binder may be used. The binder may include a single binder or a plurality of different binders. The interlayer may not include a binder, and the interlayer may be easily separated from the electrolyte layer 30 or an anode active material layer. The content of the binder included in the interlayer may be, for example, about 1 wt % to about 20 wt % based on the total weight of the interlayer.

The thickness of the interlayer may be, for example, about 1 μm to about 20 μm, or about 1 μm to about 15 μm, or about 2 μm to about 10 μm, or about 3 μm to about 7 μm. The thickness of the interlayer may be, for example, about 1% to about 50%, about 1% to about 30%, about 1% to about 10%, about 1% to about 5% of the thickness of a cathode active material layer. When the thickness of the interlayer is too small, the lithium dendrites formed between the interlayer and the anode current collector may collapse the interlayer, making it difficult to improve the cycle characteristics of a solid lithium battery. When the thickness of the interlayer is increased too much, the energy density of a solid lithium battery may be decreased and cycle characteristics may not be improved. When the thickness of the interlayer is decreased, for example, the charging capacity of the interlayer also is decreased. The charging capacity of the interlayer may be, for example, about 0.1% to about 50%, about 1% to about 30%, about 1% to about 10%, about 1% to about 5%, or about 1% to about 2% of the charging capacity of the cathode. When the charging capacity of the interlayer is too small, the lithium dendrite formed between the interlayer and the anode current collector may collapse the interlayer, making it difficult to improve the cycle characteristics of a lithium battery. When the charging capacity of the interlayer is excessively increased, the energy density of a lithium battery including the anode 20 may be decreased and the cycle characteristics thereof may not be improved. The charging capacity of a cathode active material layer may be obtained by multiplying the charging capacity density (milliampere-hours per gram (mAh/g)) of the cathode active material by the mass of the cathode active material in the cathode active material layer. Several types of cathode active materials may be used, the equation of the charging capacity density x mass value may be applied to each cathode active material, and the sum of the charging capacity values may be rendered as, e.g., equivalent to, the charging capacity of the cathode active material layer. The charging capacity of the interlayer is calculated in the same way. That is, the charging capacity of the interlayer is obtained by multiplying the charging capacity density (mAh/g) of the carbon-based material, metal-based material, or a combination thereof by the mass of the carbon-based material, metal-based material, or a combination thereof in the interlayer. Multiple types of carbon-based materials, metal-based materials or a combination thereof may be used, the equation of the charging capacity density×mass value may be applied to each material, and the total of the charging capacity values may be rendered as, e.g., equivalent to, the capacity of the intermediate layer. The charging capacity density of the cathode active material, carbon-based material, metal-based material, or a combination thereof is the capacity estimated using an all-solid half-cell using lithium metal as a counter electrode. By measuring the charging capacity using an all-solid half-cell, the charging capacity of the cathode active material layer and the interlayer is directly measured. The measured charging capacity may be divided by the mass of each active material, and the charging capacity density may be obtained. In an embodiment, the charging capacity of the cathode active material layer and the interlayer may be the initial charging capacity measured during the first charging cycle.

### Lithium Battery

The lithium battery 1000 is not particularly limited and may be a lithium primary battery, a lithium secondary battery, or a lithium air battery. The lithium battery 1000 may be, for example, a stack cell.

Referring to FIGS. 1 to 17, the lithium battery 1000 may be a lithium solid battery including a solid electrolyte. In an embodiment, the lithium battery 1000 may be, for example, a lithium ion battery including a liquid electrolyte.

The shape of the battery case 600 is not particularly limited and may include, for example, a cylindrical shape, a rectangular shape, a thin film shape, or a coin shape.

The lithium battery 1000 has excellent lifespan characteristics and high rate characteristics, and may be used in, for example, electric vehicles (EVs). For example, lithium batteries may be used for hybrid vehicles such as plug-in hybrid electric vehicles (“PHEVs”). Lithium batteries may also be used in fields in which large amounts of power storage are desired. For example, lithium batteries may be used for electric bicycles, power tools, etc.

A plurality of lithium batteries 1000 are stacked to form a battery module, and the plurality of battery modules form a battery pack. Such a battery pack may be used in any suitable device in which high capacity and high output are desired. For example, the battery pack may be used for laptops, smartphones, electric vehicles, etc. The battery module may include, for example, a plurality of batteries and a frame for holding the same. The battery pack may include, for example, a plurality of battery modules and a bus bar connecting the same. The battery module, battery pack, or a combination thereof may further include a cooling device. A plurality of battery packs may be controlled by a battery management system. The battery management system may include a battery pack and a battery control device connected to the battery pack.

The disclosure will be described in more detail through the following examples and comparative examples. However, examples are provided herein for illustrative purpose only, and do not limit the scope of the present disclosure.

### Manufacture of Lithium Batteries

### Example 1: Including Corrugated Portion

### Manufacture of Cathode Layer

LiNi_{0.8}Co_{0.1}Al_{0.1}O₂ (“NCA”) was prepared as a cathode active material, polyvinylidene fluoride was prepared as a binder, and carbon black was prepared as a conductive agent. Next, these materials were mixed with an N-Methyl-2-pyrrolidone (“NMP”) solvent at a mass ratio of cathode active material:conductive additive:binder=97:1:2. The mixture was applied on a 10 micrometer (μm) thick aluminum foil cathode current collector to produce a cathode layer. Two anode layers were prepared.

The cathode active material layer of the manufactured cathode layer was impregnated with an electrolyte solution including 2.0 moles per liter (molar, M) lithium Bis(fluorosulfonyl)imide (“LiFSI”) dissolved in the ionic liquid N-propyl-N-methyl-pyrrolidinium bis(fluorosulfonyl)imide (“Pyr13FSI”).

### Manufacture of Cathode Layer/Solid Electrolyte Layer/Anode Layer/Solid Electrolyte Layer/Cathode Layer Stack

Li_{6.5}La₃Zr_{1.5}Ta_{0.5}O₁₂ (“LLZO”) pellets with a diameter of 14 millimeters (mm) and a thickness of 500 μm were prepared as a solid electrolyte layer. LLZO pellets were treated with 1 mole per liter (mol/L) hydrochloric acid for 40 minutes and dried under vacuum.

A lithium foil having a thickness of 20 μm was placed on one side of a solid electrolyte layer, an anode current collector including a copper (Cu) thin film having a thickness of 20 μm was placed on the lithium foil, and a lithium foil having a thickness of 20 μm was placed on the anode current collector and LLZO pellets were placed on the lithium foil, and 250 megapascals (MPa) was applied at 25° C. using cold isotactic pressing (CIP) to attach a lithium metal layer to LLZO. The lithium metal layer is an anode active material layer.

A solid electrolyte layer/anode layer/solid electrolyte layer stack was prepared.

A cathode layer was placed on each of the solid electrolyte layers such that the cathode layer is in contact with the solid electrolyte layer, thereby obtaining a cathode layer/solid electrolyte layer/anode layer/solid electrolyte layer/cathode layer stack. The stack has a structure in which two unit cells are stacked.

### Manufacture of Lithium Batteries

The stack was placed in a stainless steel (“SUS”) battery case including a lower surface portion and a side portion, and the upper surface portion was sealed using the side portion and an insulator, thereby manufacturing a lithium battery.

The side portion of the battery case included a corrugated portion surrounding the middle portion of the side portion as shown in FIG. 3.

### Example 2: Including a Corrugated Portion and a First Curved Portion

The same battery case as Example 1 was used, except that the side portion of the battery case included a corrugated portion as shown in FIG. 15 and further included a first curved portion extending from the side portion.

A first cap assembly constituting the upper surface portion was additionally disposed on the side portion of the battery case via an insulator.

### Comparative Example 1: Free of Corrugated Portion, Including Elastic Member

A lithium battery was prepared in the same manner as in Example 1, except that there were no corrugated portion on the side portion of the battery case, an elastic member was disposed between the upper surface of the battery case and the stack, and a spacer was disposed between the elastic member and the stack.

The elastic member was a stainless steel (“SUS”) spring washer and the spacer was a stainless steel (“SUS”) substrate.

### Comparative Example 2: Free of Corrugated Portion, No Elastic Member

A lithium battery was manufactured in the same manner as Example 1, except that a pouch was used instead of a battery case.

### Evaluation Example 1: Energy Density Evaluation

The volume and weight of the lithium battery of Comparative Example 1 were increased compared to the lithium battery of Example 1 due to the additional placement of an elastic member between the stack and the upper surface portion of the battery case.

The energy density per unit volume and energy density per unit weight of the lithium battery of Comparative Example 1 were less than those of the lithium battery of Example 1.

### Evaluation Example 2: Evaluation of Charge/Discharge Characteristics

A charge/discharge test was performed on the lithium batteries manufactured in Examples 1 to 2 and Comparative Example 2 under the following conditions.

A lithium battery was charged with a constant current of 0.1 C until the voltage reached 4.5 volts (V) (vs. Li). When the voltage reached 4.5 V (vs. Li), the mode was changed to constant voltage mode, and when the current fell to 0.05 C or less, charging was ended. Subsequently, the open circuit voltage (“OCV”) state was maintained for 1 minute to 10 minutes, and then discharging was performed at a constant current of 0.1 C until the voltage reached 2.75 V (vs. Li).

Subsequently, during the charge/discharge cycle, charging/discharging was repeated under the same conditions while sequentially increasing the current value of the constant current from 0.2 C to 0.5 C. The discharging capacity at 0.5 C was defined as the initial discharge capacity.

Subsequently, during the charge/discharge cycle, the current value of the constant current was fixed at 0.5 C, and then charging/discharging was continuously repeated until the cycle in which the discharging capacity decreased to 80% of the initial discharge capacity.

The greater number of cycles in which the discharging capacity decreases to 80% of the initial discharging capacity, better lifespan characteristics of the lithium battery were obtained.

The lifespan characteristics of the lithium batteries of Examples 1 and 2 were improved compared to the lithium battery of Comparative Example 2 by maintaining the pressure generated by a corrugated portion during the charging and discharging process.

The lithium battery of Comparative Example 2 had poor lifespan characteristics due to a decrease in interfacial pressure due to the absence of a pressing member during the charging and discharging process.

According to one aspect, by providing a battery case with a new structure including a corrugated portion, a decrease in energy density of a lithium battery is suppressed and a decrease in cycle characteristics is prevented.

According to another aspect, by providing a battery case with a new structure including a corrugated portion, the heat dissipation characteristics of a lithium battery are improved.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A lithium battery comprising:
a unit cell stack comprising a plurality of unit cells stacked in a thickness direction of the unit cell stack; and
a battery case accommodating the unit cell stack, wherein
the battery case comprises an upper surface portion adjacent to an upper end surface of the unit cell stack, a lower surface portion adjacent to a lower end surface of the unit cell stack, and a side portion connecting the upper surface portion and the lower surface portion to each other, and
the side portion comprises a corrugated portion disposed in a thickness direction of the unit cell stack.

2. The lithium battery of claim 1, wherein a distance between opposite ends of the corrugated portion is 80% or less of a distance between the upper surface portion and the lower surface portion, and
the corrugated portion is spaced apart from each of the upper surface portion and the lower surface portion.

3. The lithium battery of claim 1, wherein the corrugated portion surrounds an outer periphery of the unit cell stack in a direction perpendicular to the thickness direction of the unit cell stack.

4. The lithium battery of claim 1, wherein the side portion comprises a plurality of corrugated portions, and
the plurality of corrugated portions are spaced apart from each other in the thickness direction of the unit cell stack.

5. The lithium battery of claim 1, wherein an inner surface of the corrugated portion is spaced apart from a side of the unit cell stack,
the corrugated portion comprises an elastic material, and the elastic material comprises a metal, and
the metal comprises stainless steel, copper, nickel, aluminum, indium, magnesium, titanium, iron cobalt, zinc, germanium, or an alloy thereof.

6. The lithium battery of claim 1, wherein the corrugated portion comprises undulations disposed in the thickness direction of the unit cell stack.

7. The lithium battery of claim 6, wherein the undulations surround an outer periphery of the unit cell stack, or
the undulations are helically coiled and surround the outer periphery of the unit cell stack.

8. The lithium battery of claim 6, wherein a number of the undulations is 5 to 1,000, and
shapes of the undulations are the same or different from each other.

9. The lithium battery of claim 6, wherein bending angles of the undulations are each independently greater than 0 to 120 degrees, or
curvature radii of the undulations are independently 10 millimeters or less.

10. The lithium battery of claim 6, wherein
the undulations comprise protrusions,
a distance between two adjacent protrusions from among the protrusions is 5% or less of a distance between the upper surface portion and the lower surface portion, or
the distance between two adjacent protrusions from among the protrusions is 10 millimeters or less.

11. The lithium battery of claim 6,
the undulations comprise protrusions,
wherein the protrusions are arranged to be spaced apart from each other in the thickness direction of the unit cell stack, and
a distance between two adjacent protrusions from among the protrusions is 100% or greater of a distance between opposite ends of a protrusion from among the protrusions.

12. The lithium battery of claim 6, wherein
the undulations comprise depressions,
a distance between two adjacent depressions from among the depressions is 5% or less of a distance between the upper surface portion and the lower surface portion, or
the distance between two adjacent depressions from among the depressions is 10 millimeters or less.

13. The lithium battery of claim 6, wherein
the undulations comprise depressions,
the depressions are arranged to be spaced apart from each other in the thickness direction of the unit cell stack, and
a distance between two adjacent depressions from among the depressions is 100% or greater of a distance between opposite ends of a depression from among the depressions.

14. The lithium battery of claim 6, wherein
the undulations comprise protrusions, and
a height between a highest point of a protrusion from among the protrusions and a surface of the side portion adjacent to the protrusion is 5% or less of a distance between the upper surface portion and the lower surface portion, or
the height between the highest point of the protrusion from among the protrusions and the surface of the side portion adjacent to the protrusion is 5 millimeters or less; or
the undulations comprise depressions, and
a height between a lowest point of a depression from among the depressions and the side portion adjacent to the depression is 5% or less of a distance between the upper surface and the lower surface, or
the height between the lowest point of the depression from among the depressions and the side portion adjacent to the depression is 5 millimeters or less; or
the undulations comprise protrusions and depressions, and
a height between a highest point of a protrusion from among the protrusions and a lowest point of a depression from among the depressions is 10% or less of a distance between the upper surface and the lower surface, or
the height between the highest point of the protrusion from among the protrusions and the lowest point of the depression from among the depressions is 10 millimeters or less.

15. The lithium battery of claim 1, further comprising an elastic member between the upper surface of the battery case and the unit cell stack, and
a spacer between the elastic member and the unit cell stack.

16. The lithium battery of claim 1, further comprising a first curved portion that extends from the side portion of the battery case and supports the upper end surface of the unit cell stack,
wherein the first curved portion is disposed to bend from the side portion of the battery case toward the inside of the battery case.

17. The lithium battery of claim 16, wherein a distal end of the first curved portion supports the upper end surface of the unit cell stack,
the first curved portion provides elastic force in the thickness direction of the unit cell stack, the first curved portion comprises a metal, and
the metal comprises copper, nickel, aluminum, indium, magnesium, titanium, iron, cobalt, zinc, germanium, or an alloy thereof.

18. The lithium battery of claim 16, wherein the upper surface portion is a first cap assembly that accommodates the first curved portion and is electrically insulated from the side portion, and
the first cap assembly comprises a fastening portion that is fastened to the side portion via an insulator.

19. The lithium battery of claim 1, further comprising a second curved portion that extends from the side portion of the battery case and supports the lower end surface of the unit cell stack,
wherein the first curved portion is disposed to bend from the side portion of the battery case toward the inside of the battery case.

20. The lithium battery of claim 19, wherein the lower surface portion is a second cap assembly that accommodates the second curved portion and is electrically insulated from the side portion, and
the second cap assembly comprises a fastening portion that is fastened to the side portion via an insulator.
